(19) United States
(12) Patent Application Publication
(10) Pub. No.: US 2010/0252955 A1
(43) Pub. Date: Oct. 7, 2010

(54) Methods of Patterning Substrates Using Microcontact Printed Polymer Resists and Articles Prepared Therefrom

(75) Inventors: Sandip AGARWAL, Somerville, MA (US); Brian T. Mayers, Arlington, MA (US); Joseph M. McLellan, Quincy, MA (US); Ralf Kügler, Cambridge, MA (US); Monika Kursawe, Seeheim-Jugenheim (DE)

Correspondence Address: STERNE, KESSLER, GOLDSTEIN & FOX P.L.L.C., 1100 NEW YORK AVENUE, N.W., WASHINGTON, DC, 20005, US

(73) Assignees: Nano Terra Inc., Cambridge, MA (US); Merck Patent GmbH, Darmstadt (DE)

(21) Appl. No.: 12/752,540

(22) Filed: Apr. 1, 2010

Related U.S. Application Data
(60) Provisional application No. 61/165,755, filed on Apr. 1, 2009.

(51) Int. Cl. B29C 59/02; C08L 41/00; C08L 37/00; C08L 39/00; C08L 55/00; C08L 25/08; C08L 33/12

(52) U.S. Cl. 264/293; 524/547; 524/549; 524/555; 524/565; 524/578; 524/560; 425/385

(57) ABSTRACT

The present invention is directed to methods for patterning substrates using contact printing to form patterns comprising a polymer, using the patterns formed therefrom as resists, and process products formed by the process.

### CROSS-REFERENCE TO RELATED APPLICATIONS

This application claims the benefit of the filing date of U.S. Appl. No. 61/165,755, filed Apr. 1, 2009, which is incorporated herein by reference in its entirety.

### BACKGROUND OF THE INVENTION

1. Field of the Invention

The present invention is directed to methods for patterning substrates using contact printing processes that employ a stamp to apply a resist composition comprising a thermoelastic polymer to a substrate, as well as resists and compositions comprising the resists.

2. Background

Resists are frequently used in the electronics industry to selectively pattern substrates by protecting predetermined areas of a substrate during etching, doping, and deposition processes and the like. Resists typically comprise a polymer and/or polymer precursor along with a solvent carrier, and are deposited by spin-coating or some other blanket deposition process. The deposited resist can then be patterned using, e.g., photolithography. Such photolithographic patterning methods, while versatile in the variety of surface features and compositions that can be patterned, are also costly and require specialized equipment and specialized resist compositions suitable for interacting with UV light. Moreover, patterning very large and/or non-rigid surfaces such as, for example, textiles, paper, plastics, and the like using photolithographic resists can be difficult and/or costly.

More recently, self-assembled monolayers have been utilized as resists wherein patterns are formed directly on a substrate by microcontact printing (see, e.g., U.S. Pat. No. 5,512,131 and related patents). Microcontact printing has demonstrated the production of surface features having lateral dimensions as small as 40 nm in a cost-effective, reproducible manner. However, the low chemical resistance of most materials that can be patterned by microcontact printing processes has in some cases limited the applications of microcontact printing.

The formation of polymeric pattern has been demonstrated using soft lithographic methods such as microcontact molding and microtransfer molding methods (see, e.g., U.S. Pat. No. 6,355,198 and related patents) in which a polymer is molded by or transferred from an indentation in a stamp.

What is needed is a resist composition that can be directly patterned by microcontact printing, and which is robust enough to provide resistance to commercially relevant etch conditions. Ideally, such a composition should be capable of forming a resist pattern suitable for producing surface features having at least one lateral dimension of 50 μm or less.

### BRIEF SUMMARY OF THE INVENTION

The present invention is directed to patterning substrates using contact-printing techniques that employ a “resist composition” comprising a thermoelastic polymer. The resist compositions are capable of forming a substantially uniform film on a stamp that is substantially free from cracks. A stamp coated with the resist composition can be contacted with a substrate to provide a pattern of the resist composition thereon, wherein the pattern has a predetermined lateral dimension defined by a pattern in the stamp surface. The resist compositions are resistant to many classes of etchants and other reactive compositions suitable for reacting with substrates of interest. In some embodiments, a thermoelastic polymers present in the resist composition is readily soluble in a variety of solvents, thereby permitting facile removal of a resist pattern from a substrate after exposure of the substrate to a reactive composition. Features formed by the methods of the present invention have lateral dimensions less than 50 μm, and permit all varieties of substrates to be patterned in a cost-effective, efficient, and reproducible manner.

The present invention is directed to a resist composition comprising: a thermoelastic polymer having a Young's Modulus of 1 MPa to 20 MPa, in a concentration of 0.1% to 10% by weight of the composition; and one or more solvents in which the thermoelastic polymer has a solubility of at least 1 mg/mL.

The present invention is also directed to a resist composition consisting essentially of: a thermoelastic polymer selected from: a styrene-ethylene copolymer, a styrene-ethylene block copolymer, a styrene-ethylene-butylene block copolymer, a styrene-isoprene copolymer, a styrene-butadiene copolymer, a styrene-butadiene block copolymer, a maleic anhydride-grafted styrene-ethylene block copolymer, a sulfonated styrene-alkylene block copolymer, an acrylonitrile-styrene-ethylene block copolymer, an arylene-vinylene copolymer, a polyethyleneimine polymer, methylmethacrylate-butadiene copolymer, and combinations thereof, wherein the thermoelastic polymer has a Young's Modulus of 20 MPa or less, the thermoelastic polymer has a molecular weight of 60,000 Da to 130,000 Da, and the thermoelastic polymer is present in a concentration of 0.1% to 10% by weight; and one or more solvents having a boiling point of 35° C. to 200° C.

In some embodiments, the solvent is selected from the group consisting of: benzene, toluene, a xylene, cumene, mesitylene, propylene glycol mono-methyl ether, tetrahydrofuran, acetone, ethylacetate, methylethylketone, methylene chloride, 1,2-dichloroethane, chloroform, dimethylformamide, and combinations thereof. In some embodiments, the solvent is toluene.

The methods of the present invention are generally applicable to use with a wide variety of resists, and the methods are in no way limited by the resist compositions described herein. Thus, the present invention is also directed to a method for forming a feature on a substrate, the method comprising:
applying a resist composition comprising a thermoelastic polymer to a surface of a stamp to provide a coated stamp, wherein the stamp comprises a flexible material and the stamp surface includes at least one indentation therein, the indentation being contiguous with and defining a pattern in the surface of the stamp;
contacting the coated stamp with a substrate for an amount of time and at a temperature sufficient to transfer the thermoelastic polymer from the stamp surface to the substrate, wherein the thermoelastic polymer covers the substrate in a pattern according to the pattern in the surface of the stamp;
separating the stamp from the substrate; and
reacting an area of the substrate with a reactive composition to form a feature thereon, wherein the pattern in the surface of the stamp defines a lateral dimension of the feature.

The present invention is also directed to a composition comprising: a stamp comprising a flexible material, the stamp having a surface including at least one indentation therein, the indentation being contiguous with and defining a pattern in the surface of the stamp, and having on the surface a resist composition comprising a thermoelastic polymer, wherein the thermoelastic polymer has a Young's Modulus of 20 MPa or less, and has a molecular weight of 60,000 Da to 130,000 Da.

The present invention is also directed to a composition comprising: a substrate having a surface, and on the surface a pattern comprising a thermoelastic polymer, wherein the pattern has at least one spacing of 50 μm or less, the thermoelastic polymer has a Young's Modulus of 20 MPa or less, wherein the pattern absorbs 10% or less of radiation having a wavelength of about 250 nm to about 800 nm for 100 nm of pattern thickness, and the thermoelastic polymer has a molecular weight of 60,000 Da to 130,000 Da.

In some embodiments, the thermoelastic polymer pattern has a thickness of 25 nm to 10 μm. In some embodiments, the resist composition forms a discontinuous coating on the stamp and/or the substrate.

In some embodiments, the method further comprises pre-treating a surface selected from: the surface of the stamp, the substrate, and combinations thereof. In some embodiments, the pre-treating is a process selected from: cleaning, oxidizing, reducing, derivatizing, functionalizing, exposing to a reactive gas, exposing to a plasma, exposing to thermal energy, exposing to ultraviolet radiation, and combinations thereof.

In some embodiments, the contacting comprises conformally contacting the surface of the stamp with the substrate. In some embodiments, the contacting further comprises applying pressure or vacuum to the backside of the stamp, the backside of the substrate, or a combination thereof.

In some embodiments, the temperature of at least one of the stamp, the substrate, and the thermoelastic polymer is maintained at or above a T_{g} of the thermoelastic polymer during the contacting.

In some embodiments, a method further comprises annealing the thermoelastic polymer.

In some embodiments, the substrate is maintained at a temperature at or below a T_{g} of the thermoelastic polymer during the reacting. In some embodiments, the substrate is maintained at a temperature of 30° C. to 150° C. during the reacting.

In some embodiments, the reacting is performed for 0.5 seconds to 80 seconds.

In some embodiments, a method further comprises removing the thermoelastic polymer pattern from the substrate.

In some embodiments, the reacting further comprises exposing the substrate to a reaction initiator selected from: thermal energy, radiation, acoustic waves, a plasma, an electron beam, a stoichiometric chemical reagent, a catalytic chemical reagent, a reactive gas, an increase or decrease in pH, an increase or decrease in pressure, electrical current, agitation, friction, and combinations thereof.

In some embodiments, the reactive composition comprises a species selected from the group consisting of: an acid, a base, halogen-containing compound, a halide, and combinations thereof.

In some embodiments, the substrate is selected from: a glass, a ceramic, a polymer, a metal, and laminates, composites and alloys thereof.

In some embodiments, the resist composition has a viscosity of 0.5 cP to 10 cP.

In some embodiments, the thermoelastic polymer is present in a concentration of 1% to 4% by weight of the composition.

In some embodiments, the thermoelastic polymer is selected from the group consisting of: a styrene-butadiene copolymer, a styrene-isoprene copolymer, a polystyrene-poly(ethylene/butylene)-polystyrene triblock copolymer grafted with maleic anhydride, and combinations thereof. In some embodiments, the thermoelastic polymer is a styrene-ethylene-butylene block copolymer having a molecular weight of about 118,000 Da. In some embodiments, the thermoelastic polymer is an ethoxylated polyethyleneimine polymer having a molecular of about 70,000 Da.

In some embodiments, the thermoelastic polymer has a Young's Modulus of 1 MPa to 20 MPa. In some embodiments, the thermoelastic polymer has a Young's Modulus of 2 MPa to 4 MPa.

In some embodiments, the thermoelastic polymer has a T_{g} of 25° C. or less. In some embodiments, the thermoelastic polymer has a T_{g} of −60° C. to −30° C. In some embodiments, the thermoelastic polymer comprises a first polymer having a T_{g} of 25° C. or less and a second polymer having a T_{g} of 25° C. or greater.

In some embodiments, a film or pattern prepared from the resist composition absorbs 10% or less of radiation having a wavelength of about 250 nm to about 800 nm for each 100 nm of pattern or film thickness.

In some embodiments, the thermoelastic polymer has a melting point of 80° C. to 125° C.

In some embodiments, the thermoelastic polymer pattern has a vertical dimension of 25 nm to 10 μm.

In some embodiments, the pattern has 2 defects or less per 100 features.

Further embodiments, features, and advantages of the present inventions, as well as the structure and operation of the various embodiments of the present invention, are described in detail below with reference to the accompanying drawings.

### BRIEF DESCRIPTION OF THE DRAWINGS

The accompanying drawings, which are incorporated herein and form a part of the specification, illustrate one or more embodiments of the present invention and, together with the description, further serve to explain the principles of the invention and to enable a person skilled in the pertinent art to make and use the invention.

FIGS. 1A-1E and 1F-1G provide schematic cross-sectional representations of substrates having features thereon that can be prepared by a method of the present invention.

FIG. 2 provides a schematic cross-sectional representation of a curved substrate having features thereon that can be prepared by a method of the present invention.

FIG. 3 provide a flow chart of a process of the present invention.

FIGS. 4A-4D provide a schematic, cross-sectional representation of a process of the present invention for forming a feature on a substrate.

FIG. 5 provides a schematic cross-sectional representation of a coated composition comprising a stamp having a surface including at least one indentation therein, the indentation being contiguous with and defining a pattern in the surface of the stamp, and having on the surface a polymer composition of the present invention.

FIGS. 6 and 7A-7B provide schematic cross-sectional representations of a composition comprising a substrate having a surface, and having thereon a pattern comprising the thermoelastic polymer composition of the present invention.

FIGS. 8A-8B and 8C-8D provide top-view images of representative defects produced by soft lithographic printing processes that are avoided by a method of the present invention.

FIGS. 9 and 10 provide top-view microscope images of a composition of the present invention comprising a substrate having a resist pattern thereon.

FIG. 11 provides a top-view microscope image of a composition of the present invention comprising a substrate having a pattern thereon comprising subtractive non-penetrating features.

FIG. 12 provides a graphic representation of a scanning profilometry profile of the substrate having a pattern thereon, as provided in FIG. 11.

FIGS. 13, 14 and 15 provide top-view microscope images of compositions of the present invention comprising a substrate having a pattern thereon comprising subtractive non-penetrating features.

FIGS. 16A-16C provide top-view microscope images of compositions of the present invention prepared at various temperatures.

FIGS. 17A-17C provide top-view microscope images of features prepared by the methods of the present invention.

One or more embodiments of the present invention will now be described with reference to the accompanying drawings. In the drawings, like reference numbers can indicate identical or functionally similar elements. Additionally, the left-most digit(s) of a reference number can identify the drawing in which the reference number first appears.

### DETAILED DESCRIPTION OF THE INVENTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

### Substrates

The polymeric patterns prepared by the methods of the present invention are formed on a substrate. Substrates suitable for patterning by the methods of the present invention are not particularly limited by size, composition or geometry. For example, the present invention is suitable for patterning planar, non-planar, flat, curved, spherical, rigid, flexible, symmetric, and asymmetric objects and surfaces, and any combination thereof. The methods are also not limited by surface roughness or surface waviness, and are equally applicable to smooth, rough and wavy substrates, and substrates exhibiting heterogeneous surface morphology (i.e., substrates having varying degrees of smoothness, roughness and/or waviness).

As used herein, a substrate is “planar” if, after accounting for random variations in the height of a substrate (e.g., surface roughness, waviness, etc.), points on the surface of the substrate lie in approximately the same plane. Planar substrates can include, but are not limited to, windows, embedded circuits, sheets, and the like. Planar substrates can include flat variants of the above having holes there through.

As used herein, a substrate is “non-planar” if, after accounting for random variations in the height of a substrate (e.g., surface roughness, waviness, etc.), points on the surface of the substrate do not lie in the same plane. Non-planar substrates can include, but are not limited to, gratings, substrates having a tiered geometry, and the like. Non-planar substrates can comprise both flat and/or curved areas. As used herein, a substrate is “curved” when the radius of curvature of a substrate is non-zero over a distance of 100 μm or more, or 1 mm or more, across the surface of a substrate.

As used herein, a substrate is “rigid” when the plane, curvature, and/or geometry of a substrate cannot be easily distorted. Rigid substrates can undergo temperature-induced distortions due to thermal expansion, or become flexible at temperatures above a glass transition, and the like. On the other hand, the plane, curvature, and/or geometry of a substrate can be distorted flexed, and/or undergo elastic or plastic deformation, bending, compression, twisting, and the like in response to applied external force, stress, strain and/or torsion.

Flexible substrates suitable for use with the present invention include, but are not limited to, polymers (e.g., plastics), woven fibers, thin films, metal foils, composites thereof, laminates thereof, and combinations thereof. In some embodiments, a flexible substrate can be patterned using the methods of the present invention in a reel-to-reel manner.

Substrates for use with the present invention are not particularly limited by composition. Substrates suitable for use with the present invention include materials selected from metals, crystalline materials (e.g., monocrystalline, polycrystalline, and partially crystalline materials), amorphous materials, conductors, semiconductors, insulators, optics, painted substrates, fibers, glasses, ceramics, zeolites, plastics, thermosetting and thermoplastic materials (e.g., optionally doped: polyacrylates, polycarbonates, polyurethanes, polystyrenes, cellulosic polymers, polyolefins, polyamides, polyimides, resins, polyesters, polyphenylenes, and the like), films, thin films, foils, plastics, polymers, wood, fibers, minerals, biomaterials, living tissue, bone, alloys thereof, composites thereof, laminates thereof, porous variants thereof, doped variants thereof, and combinations thereof.

In some embodiments, at least a portion of a substrate is conductive or semiconductive. As used herein, “conductive” and “semiconductive” materials include species, compounds, polymers, films, coatings, substrates, and the like capable of transporting or carrying electrical charge. Generally, the charge transport properties of a semiconductive material can be modified based upon an external stimulus such as, but not limited to, an electrical field, a magnetic field, a temperature change, a pressure change, exposure to radiation, and combinations thereof. In some embodiments, a conductive or semiconductive material has an electron or hole mobility of 10⁻⁶ cm²/V·s or more.

Electrically conductive and semiconductive materials include, but are not limited to, metals, alloys, thin films, crystalline materials, amorphous materials, polymers, laminates, foils, plastics, and combinations thereof.

In some embodiments, a substrate comprises a semiconductor such as, but not limited to: crystalline silicon, polycrystalline silicon, amorphous silicon, p-doped silicon, n-doped silicon, silicon oxide, silicon germanium, germanium, gallium arsenide, gallium arsenide phosphide, indium tin oxide, and combinations thereof.

As used herein, a “dielectric” refers to species, compounds, polymers, films, coatings, substrates, and the like that are resistant to the movement or transfer of electrical charge. In some embodiments, a dielectric has a dielectric constant, ρ, of 1.5 to 8, 1.7 to 5, 1.8 to 4, 1.9 to 3, 2 to 2.7, 2.1 to 2.5, 8 to 90, 15 to 85, 20 to 80, 25 to 75, or 30 to 70. Dielectrics suitable for use with the present invention include, but are not limited to, plastics, polymers (e.g., polydimethylsiloxane, a silsesquioxane, a polyethylene, a polypropylene, and the like), silicon oxide, metal oxides (e.g., aluminum oxide, hafnium oxide, tantalum oxide, niobium oxide, etc.), metal carbides, metal nitrides, ceramics (e.g., silicon carbide, hydrogenated silicon carbide, silicon nitride, silicon carbonitride, silicon oxynitride, silicon oxycarbide, and combinations thereof), glasses (e.g., SiO₂, borosilicate glass, borophosphorosilicate glass, organosilicate glass, etc., and fluorinated and porous variants thereof), zeolites, minerals, biomaterials, living tissue, bone, monomeric precursors thereof, particles thereof, and combinations thereof.

In some embodiments, substrate comprises a flexible substrate, such as, but not limited to: a plastic, a composite, a laminate, a thin film, a metal foil, and combinations thereof. In some embodiments, the flexible substrate can be patterned by a method of the present invention in a reel-to-reel or roll-to-roll manner.

Plastics suitable for use with the present invention include those materials disclosed, for example but not limitation, in Plastics Materials and Processes: A Concise Encyclopedia, Harper, C. A. and Petrie, E. M., John Wiley and Sons, Hoboken, N.J. (2003) and Plastics for Engineers: Materials, Properties, Applications, Domininghaus, H., Oxford University Press, USA (1993), which are incorporated herein by reference in their entirety.

Exemplary substrates on which a polymeric pattern can be formed by the present invention include, but are not limited to, windows; mirrors; optical elements (e.g, optical elements for use in eyeglasses, cameras, binoculars, telescopes, and the like); watch crystals; holograms; optical filters; data storage devices (e.g., compact discs, DVD discs, CD-ROM discs, and the like); flat panel electronic displays (e.g., LCDs, plasma displays, and the like); touch-screen displays (such as those of computer touch screens and personal data assistants); solar cells; photovoltaics; LEDs; lighting; flexible electronics; flexible displays (e.g., electronic paper and electronic books); cellular phones; global positioning systems; calculators; diagnostics; sensors; resist layers; biological interfaces; antireflection coatings; graphic articles (e.g., signage); batteries; fuel cells; antennas; motor vehicles; artwork (e.g., sculptures, paintings, lithographs, and the like); jewelry; and combinations thereof.

### Features and Patterns

The present invention provides methods for forming a feature in or on a substrate.

As used herein, a “feature” refers to an area of a substrate that is contiguous with, and can be distinguished from, the areas of the surface surrounding the feature. For example, a feature can be distinguished from the areas of the substrate surrounding the feature based upon the topography of the feature, composition of the feature, or another property of the feature that differs from the surrounding substrate.

Features can be defined by their physical dimensions. All features have at least one lateral dimension. As used herein, a “lateral dimension” refers to a dimension of a feature or a dimension of a pattern comprising a thermoelastic polymer that is parallel or tangential to the surface of a substrate on which the feature or pattern is formed. One or more lateral dimensions of a feature define, or can be used to define, the area of a substrate that a feature or a pattern occupies. Typical lateral dimensions of features include, but are not limited to: length, width, radius, diameter, and combinations thereof. Generally, a lateral dimension of a feature are defined by the lateral dimensions of a pattern.

All features and thermoelastic polymer patterns also have at least one vertical dimension that can be described by a vector that lies out of the plane of a substrate. As used herein, an “elevation” of a feature refers to the largest vertical distance between the average height of the surface of a substrate and the lowest surface of the feature. A conformal feature has an elevation of zero (i.e., is at the same height as the surface of a substrate). As used herein, an “elevation” of a pattern comprising a thermoelastic polymer refers to the vertical distance between the average height of the surface of a substrate and the highest point of the pattern.

Features produced by the methods of the present invention can generally be classified into two groups: conformal features and subtractive features, based upon the elevation of the feature relative to the plane of a substrate. A “conformal” feature is substantially even with the surface of a substrate. A “subtractive” feature is substantially below the surface of the substrate. A subtractive feature is formed by removing a portion of the substrate.

Features produced by the methods of the present invention can be further classified into two-subgroups: penetrating and non-penetrating. As used herein, the “penetration distance” refers to the distance between the lowest point of a feature and the height of the surface of the substrate adjacent to the feature. A feature is “penetrating” when a portion of the feature extends below the surface of the feature. A feature is “non-penetrating” when the maximum elevation of a feature into the surface of a substrate is equivalent to the surface of the feature. A non-penetrating feature has a penetration distance of zero.

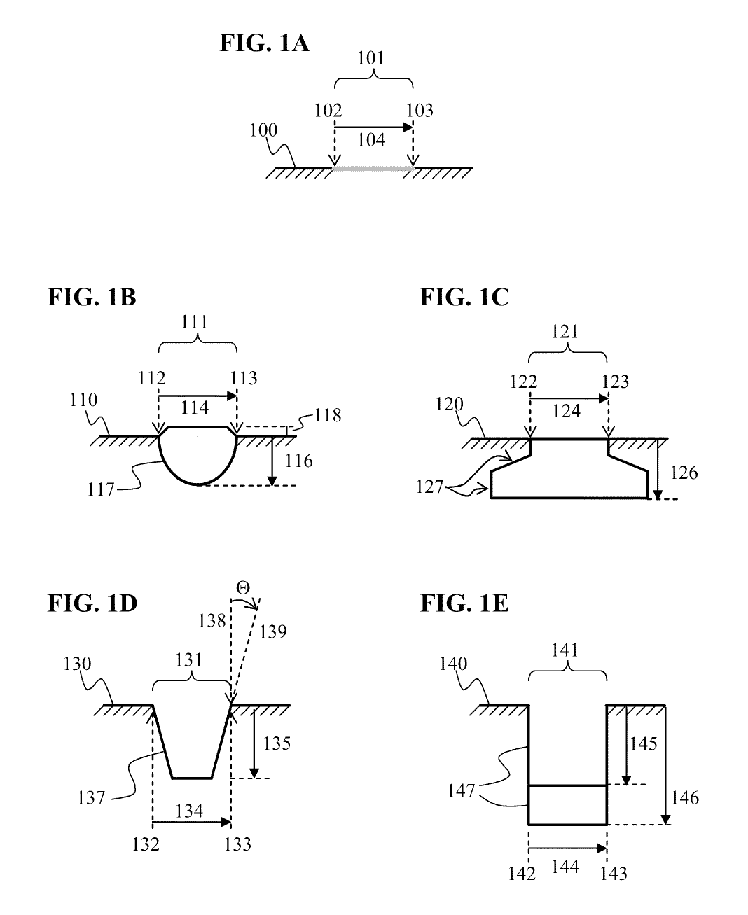

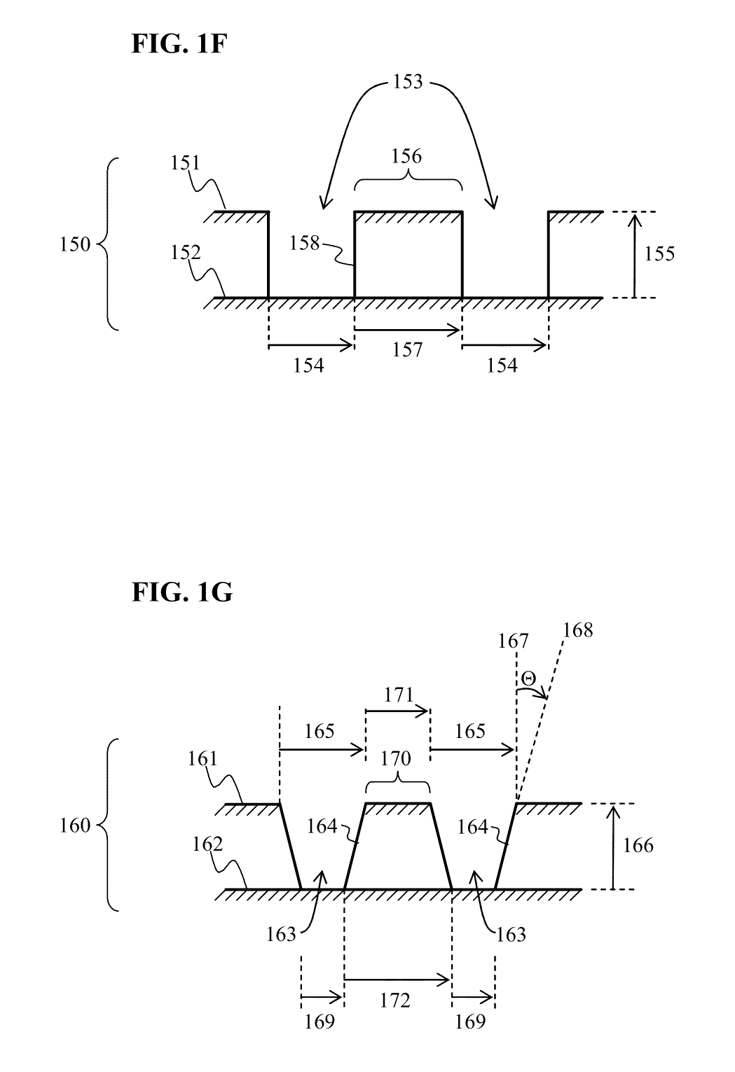

As used herein, a “conformal feature” refers to a feature having an elevation that is substantially even with the surface of a substrate. In some embodiments, a conformal feature has substantially the same topography as the surrounding substrate. As used herein, a “conformal non-penetrating” feature refers to a feature that is wholly on the surface of a substrate. For example, a reactive composition that reacts with the exposed portion of a substrate such as, for example, by oxidizing, reducing, or functionalizing exposed chemical bonds and/or functional groups of a substrate, can form a conformal non-penetrating feature. FIG. 1A provides a cross-sectional schematic representation of a substrate, 100, having a “conformal non-penetrating” feature, 101, thereon. The feature, 101, has a lateral dimension, 104, an elevation of zero, and a penetration distance of zero. FIG. 1B provides a cross-sectional schematic representation of a substrate, 110, having a substantially “conformal penetrating” feature, 111, thereon. The feature, 111, has a lateral dimension equivalent to the magnitude of vector 114, and a penetration distance equivalent to the magnitude of vector 116. The feature, 111, has an elevation, 118, greater than that of the surrounding substrate, but is nonetheless considered substantially conformal for the purposes of the present invention. As used herein, “substantially conformal” features includes features having an elevation of 1 nm or less, 8 Å or less, 5 Å or less, or 2 Å or less above or below the elevation of the surrounding substrate. The feature, 111, also has a sidewall, 117. FIG. 1C provides a cross-sectional schematic representation of a substrate, 120, having a “conformal penetrating” feature, 121, thereon. The feature, 121, has a lateral dimension equivalent to the magnitude of vector 124, an elevation of zero, and penetration distance equivalent to the magnitude of vector 126. The feature, 121, has a sidewall, 127.

As used herein, a “subtractive feature” refers to a feature having an elevation that is below the plane of a substrate. FIG. 1D provides a cross-sectional schematic representation of a substrate, 130, having a “subtractive non-penetrating” feature, 131, thereon. The feature, 131, has a lateral dimension equivalent to the magnitude of vector 134, an elevation equivalent to the magnitude of vector 135, and penetration distance of zero. The feature, 131, has a sidewall, 137. FIG. 1E provides a cross-sectional schematic representation of a substrate, 140, having a “subtractive penetrating” feature, 141, thereon. The feature, 141, has a lateral dimension equivalent to the magnitude of vector 144, an elevation equivalent to the magnitude of vector 145, and a penetration distance equivalent to the magnitude of vector 146. The feature, 141, has a sidewall, 147.

A feature produced by the methods of the present invention and/or a pattern comprising a thermoelastic polymer has a lateral dimension and a vertical dimension that can be defined in units of length, such as angstroms (Å), nanometers (nm), microns (μm), millimeters (mm), centimeters (cm), etc.

When a substrate is planar, a lateral dimension of a pattern is the magnitude of a vector between two points located on opposite sides of a portion of the pattern, wherein the two points are in the plane of the substrate, and wherein the vector is parallel to the plane of the substrate. In some embodiments, two points used to determine a lateral dimension of a symmetric surface also lie on a mirror plane of the symmetric feature. In some embodiments, a lateral dimension of an asymmetric feature can be determined by aligning the vector orthogonally to at least one edge of the feature.

When an area of a substrate surrounding a feature is planar, a lateral dimension of a feature is the magnitude of a vector between two points located on opposite sides of a feature, wherein the two points are in the plane of the substrate, and wherein the vector is parallel to the plane of the substrate. In some embodiments, two points used to determine a lateral dimension of a symmetric surface also lie on a mirror plane of the symmetric feature. In some embodiments, a lateral dimension of an asymmetric feature can be determined by aligning the vector orthogonally to at least one edge of the feature. Referring to FIGS. 1A-1E, the lateral dimensions of features 101, 111, 121, 131 and 141, are defined by points lying in the plane of a substrate and on opposite sides of the features, shown by dashed arrows, 102 and 103; 112 and 113; 122 and 123; 132 and 133; and 142 and 143, respectively. The lateral dimension of these features is equivalent to the magnitude of the vectors 104, 114, 124, 134 and 144, respectively.

In some embodiments, a feature has an “angled” sidewall. As used herein, an “angled sidewall” refers to a sidewall that is not orthogonal to a plane oriented parallel or tangent to a substrate. Referring to FIG. 1D, the sidewall angle is equal to the average angle, Θ, formed between a vector orthogonal to the surface that intersects an edge of a feature, 137, and a vector intersecting the edge of the feature at the same point that is parallel to the surface of the sidewall, 138. An orthogonal sidewall has a sidewall angle of about 0°. Referring to FIG. 1D, for example, the feature 131, having a sidewall, 137, has a sidewall angle, Θ. While the sidewall angle depicted in FIG. 1D is constant over the surface of the sidewall, 131, the sidewall angle can also vary. For example, features having curved, faceted and sloped sidewalls are within the scope of the present invention. For example, referring to FIG. 1B, the feature, 111, forms a curved sidewall, 117, in which the substrate, 110, surrounds the sidewall. In some embodiments, a feature includes a sidewall that is curved and/or sloped near the top and/or bottom of the feature. An “average sidewall angle” can be calculated by averaging an angle formed between a point on a sidewall and the substrate over the surface of the sidewall. In some embodiments, a feature formed by the methods of the present invention has a sidewall angle or an average sidewall angle of 80° to −50°, 80° to −30°, 80° to −10°, or 80° to 0°.

For a curved substrate, a lateral dimension is defined as the magnitude of a segment of the circumference of a circle connecting two points on opposite sides of a feature, wherein the circle has a radius equal to the radius of curvature of the substrate. A lateral dimension of a curved substrate having multiple or undulating curvature, or waviness, can be determined by summing the magnitude of segments from multiple circles.

In some embodiments, one or more isolated areas of a substrate are created by a continuous pattern of trenches, lines, or other subtractive features formed by a method of the present invention. In such embodiments, the features can be further characterized by the lateral dimensions of the areas of the substrate separating the features (i.e., the dimensions of the spacing between the features). FIG. 1F provides a schematic cross-sectional representation of a composite substrate, 150, comprising a surface layer, 151, and an under layer, 152. In some embodiments, a composite substrate comprises a conductive surface layer, 151, and an insulative or semi-conductive under layer, 152. A pattern of subtractive non-penetrating features, 153, is formed in the surface layer, 151, by a method of the present invention, such that areas of the under layer, 152, are exposed. As described herein, the subtractive non-penetrating features, 153, have at least one lateral dimension, 154, of 50 μm or less. The subtractive non-penetrating features also have at least one vertical dimension, 155. The pattern of subtractive features forms an isolated area of the surface layer, 156, having at least one lateral dimension, 157, defined by the spacing of the subtractive features. The subtractive features include a sidewall, 157, which also forms a sidewall of the isolated areas of the surface layer of the composite substrate.

In some embodiments, adjacent subtractive features on a substrate have a spacing and form an isolated area of the substrate having at least one lateral dimension of 50 μm or less, 40 μm or less, 25 μm or less, 20 μm or less, 15 μm or less, 10 μm or less, 7 μm or less, 5 μm or less, 2 μm or less, 1 μm or less or 500 nm or less.

FIG. 1G provides a schematic cross-sectional representation of a composite substrate, 160, comprising a surface layer, 161, and an under layer, 162. A pattern of subtractive non-penetrating features, 163, having angled sidewalls, 164, is formed in the surface layer, 161, by a method of the present invention, such that areas of the under layer, 162, are exposed. As described herein, the subtractive non-penetrating features, 163, have at least one lateral dimension, 165, of 50 μm or less. Because the features have an angled sidewall, 164, the base of the features has a second lateral dimension, 169, which is the lateral dimension at the base of the features. It is within the scope of the present invention that for features having angled sidewalls, 165>169 or 165<169. The subtractive non-penetrating features also have at least one vertical dimension, 166. The angled sidewall portion, 164, has an average sidewall angle, θ, determined by the average angle formed between a line perpendicular to the substrate, 167, and a line oriented parallel to the average slope of the sidewall, 168. The pattern of subtractive features forms an isolated area of the surface layer, 170, having at least one lateral dimension, 171, defined by the spacing of the subtractive features. Because the features have an angled sidewall, 164, the isolated area, 170, also includes a second lateral dimension, 172, at the base of the substrate. The second later dimension, 172, differs from the at least one lateral dimension of the isolated area at the surface of the substrate. The difference between the lateral dimensions, 171 and 172, can be used in combination with the vertical dimension, 166, to calculate the average sidewall angle, θ. For example, the average sidewall angle, θ, can be determined using the following equation: tan θ={[(171−172)/2]/166}, wherein “tan” is the tangent function, and the other terms are as defined herein.

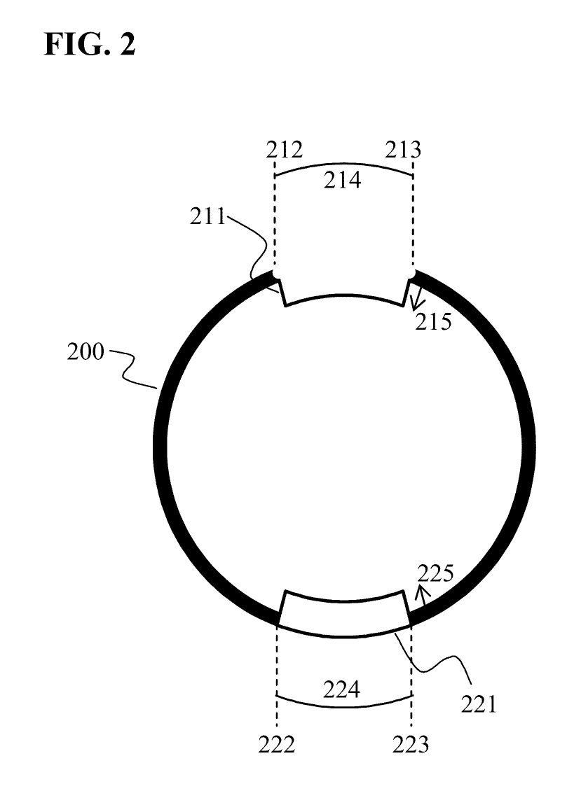

FIG. 2 provides a cross-sectional representation of a curved substrate, 200, having a subtractive non-penetrating feature, 211, and a conformal penetrating feature, 221. A lateral dimension of the subtractive non-penetrating feature, 211, is equivalent to the length of the line segment, 214, which can connect points 212 and 213. The elevation of feature 211 is provided by the magnitude of vector 215. The feature, 211, has a penetration distance of zero. Similarly, a lateral dimension of the conformal penetrating feature, 221, is equivalent to the length of the line segment, 224, which connect points 222 and 223. The feature, 221, has an elevation of zero and a penetration distance equivalent to the magnitude of vector 225.

Not being bound by any particular theory, the lateral dimensions of a feature are effectively determined by the spacing between adjacent regions of a pattern comprising a thermoelastic polymer. Therefore, in some embodiments, a feature produced by a method of the present invention has at least one lateral dimension of 40 nm to 50 μm, 50 nm to 25 μm, 100 nm to 20 μm, 200 nm to 15 μm, 300 nm to 10 μm, 500 nm to 5 μm, 750 nm to 3 μm, 900 nm to 2 μm, about 1 μm, about 1.5 μm, about 2 μm, about 2.5 μm, about 3 μm, or about 5 μm. In some embodiments, a feature and/or a spacing between areas of a substrate having a thermoelastic polymer pattern thereon have at least one lateral dimension of 40 μm or less, 30 μm or less, 20 μm or less, 15 μm or less, 10 μm or less, 7 μm or less, 6 μm or less, 5 μm or less, 2 μm or less, or 1 μm or less.

As used herein, “at least one lateral dimension” refers to a pattern spacing and a feature of the present invention having multiple lateral dimensions, of which one or more of the lateral dimensions is 50 μm or less. Thus, it is within the scope of the present invention for patterns and features to have spacings and/or lateral dimensions greater than 50 μm, so long as a portion of the pattern or a portion of the feature has a lateral dimension of 50 μm or less.

In some embodiments, a feature has a vertical dimension (i.e., an elevation and/or a penetration distance) of 1 nm to 40 μm, 10 nm to 30 μm, 50 nm to 25 μm, 100 nm to 20 μm, 200 nm to 15 μm, 500 nm to 10 μm, 1 μm to 5 μm, about 4 μm, about 3 μm, about 2 μm, about 1 μm, about 750 nm, about 500 nm, about 400 nm, about 300 nm, or about 200 nm into the surface of a substrate. In some embodiments, a feature produced by a method of the present invention has an elevation or penetration distance of 3 Å to 25 μm, 5 Å to 10 μm, 8 Å to 5 μm, 1 nm to 2 μm, 2 nm to 1 μm, 5 nm to 900 nm, 10 nm to 700 nm, 15 nm to 600 nm, 20 nm to 500 nm, 25 nm to 400 nm, 30 nm to 300 nm, 40 nm to 200 nm, 50 nm, 75 nm, 100 nm, or 150 nm into the surface of a substrate.

In some embodiments, a pattern comprising a thermoelastic polymer has a vertical dimension (i.e., an elevation) of 25 nm to 10 μm. In some embodiments, a pattern has: a minimum vertical dimension of 25 nm, 30 nm, 40 nm, 50 nm, 60 nm, 75 nm, 100 nm, 150 nm, 200 nm, 250 nm, 300 nm, 400 nm, 500 nm, or 750 nm; a maximum vertical dimension of 10 μm, 7.5 μm, 5 μm, 2 μm, 1 μm, 900 nm, 800 nm, 700 nm, 600 nm, 500 nm, 400 nm, 350 nm, or 300 nm; or a vertical dimension within a range proscribed by any of the minimum and maximum vertical dimensions recited herein (e.g., vertical dimensions of 25 nm to 10 μm, 25 nm to 7.5 μm, etc.).

In some embodiments, a feature produced by a method of the present invention has an aspect ratio (i.e., a ratio of an elevation to a lateral dimension) of 10:1 to 1:100,000, 8:1 to 1:100, 7:1 to 1:80, 6:1 to 1:50, 5:1 to 1:20, 4:1 to 1:15, 3:1 to 1:10, 2:1 to 1:8, 2:1 to 1:5, 2:1 to 1:2, about 1:1, about 1:2, about 1:3, about 1:4, about 1:5, about 1:10, about 1:20, about 1:50, about 1:100, about 1:1,000, about 1:10,000, about 1:50,000, or about 1:100,000.

In some embodiments, a pattern has at least one spacing of 50 μm or less, 40 μm or less, 30 μm or less, 25 μm or less, 20 μm or less, 15 μm or less, 10 μm or less, 5 μm or less, or 1 μm or less.

A lateral and/or vertical dimension of a feature and/or a pattern comprising a thermoelastic polymer on a substrate can be determined using an analytical method that can measure the topography of a substrate such as, for example, scanning mode atomic force microscopy (AFM) or profilometry. Conformal features cannot typically be detected by profilometry methods. However, if the surface of a conformal feature is terminated with a functional group whose polarity differs from that of the surrounding substrate, a lateral dimension of the feature can be determined using, for example, tapping mode AFM, functionalized AFM, or scanning probe microscopy.

Not being bound by any particular theory, a feature and/or a pattern comprising a thermoelastic polymer can be differentiated from the surrounding substrate using can also be identified based upon a property such as, but not limited to, conductivity, resistivity, density, permeability, porosity, hardness, and combinations thereof using, for example, scanning probe microscopy, scanning electron microscopy, and the like, as well as any other analytical methods known to persons of ordinary skill in the art.

Typically, a feature and/or a pattern comprising a thermoelastic polymer has a different composition or morphology compared to the substrate. Thus, surface analytical methods can be employed to determine both the composition of the feature and/or the pattern, as well as the lateral dimension(s) of the feature and/or the pattern. Analytical methods suitable for use with the present include, but are not limited to, Auger electron spectroscopy, energy dispersive x-ray spectroscopy, micro-Fourier transform infrared spectroscopy, particle induced x-ray emission, Raman spectroscopy, x-ray diffraction, x-ray fluorescence, laser ablation inductively coupled plasma mass spectrometry, Rutherford backscattering spectrometry/Hydrogen forward scattering, secondary ion mass spectrometry, time-of-flight secondary ion mass spectrometry, x-ray photoelectron spectroscopy, and combinations thereof, and other surface analytical methods known to persons of ordinary skill in the art.

### Resist Compositions

In some embodiments, the present invention is directed to an resist composition consisting essentially of: a thermoelastic polymer having a Young's Modulus of 1 MPa to 20 MPa, in a concentration of 0.1% to 10% by weight of the composition; and one or more solvents in which the thermoelastic polymer has a solubility of at least 1 mg/mL.

As used herein, a “resist composition” refers to a composition that includes a thermoelastic copolymer that is chemically resistant to a reactive composition capable of reacting with a substrate. Resist compositions can refer to inks, gels, creams, pastes, glues, adhesives, and any other liquid, semi-liquid, viscous, solid, pourable, flowable, or meltable materials.

As used herein, “consisting essentially” refers to the resist compositions including one or more thermoelastic polymers and one or more solvents having the properties specified herein. Thus, the resist compositions of the present invention can include thermoelastic polymer blends, and multicomponent solvent mixtures so long as at least one of each component is present in the resist composition.

As used herein, a “thermoelastic polymer” refers to a composition that can undergo deformation upon heating and becomes firm when cooled, with the process able to be repeated without decomposing or burning. As used herein, “thermoelastic polymer” is generally synonymous with the term “thermoplastic”, which denotes polymeric materials that can be molded, remolded, welded and the like by heating and re-heating cycles above a glass transition temperature, T_{g}.

Thermoelastic polymers suitable for use with the present invention include, but are not limited to, an acrylonitrile butadiene styrene (“ABS”), an acrylic polymer, a celluloid polymer, a cellulose acetate, an ethylene-vinyl acetate (“EVA”), an ethylene vinyl alcohol (“EVAL”), a fluoropolymer (e.g., poly(tetrafluoroethylene), “PTFE”), a mixture of an acrylic polymer and a polyvinylchloride polymer (e.g., KYDEX®, Kleerdex Co. LLC, Mt. Laurel, N.J.), a polyacetal, a polyacrylonitrile, a polyamide (e.g., a NYLON®, E. I. Du Pont de Nemours and Co., Wilmington, Del.), a polyamide-imide (“PAI”), a polyaryletherketone, a polybutadiene, a polybutylene, a polybutylene terephthalate, a polychlorotrifluoroethylene, a polyethylene terephthalate (“PET”), a polycyclohexylene dimethylene terephthalate (“PCT”), a polycarbonate (“PC”), a polyhydroxyalkanoate (“PHA”), a polyketone (“PK”), a polyester, a polyethylene (“PE”), a polyetheretherketone (“PEEK”), a polyetherimide (“PEI”), a polyethersulfone (“PES”), a polyethylenechlorinate (“PEC”), a polyimide (“PI”), a polylactic acid (PLA), a polymethylpentene (“PMP”), a polyphenylene oxide (“PPO”), a polyphenylene sulfide (“PPS”), a polyphthalamide (“PPA”), a polypropylene (“PP”), a polystyrene (“PS”), a polysulfone (“PSU”), a polyvinyl chloride (“PVC”), a polyvinylidene chloride (“PVDC”), and combinations thereof.

In some embodiments, the thermoelastic polymer is selected from the group consisting of: styrene-butadiene random copolymer, styrene-butadiene triblock copolymer, styrene-isoprene random copolymer, styrene-(ethylene-butylene) triblock copolymer, styrene-(ethylene-butylene) triblock copolymer grafted with maleic anhydride, acrylonitrile-butadiene random copolymer, poly(ethylene-butylene), and combinations thereof.

In some embodiments, the thermoelastic polymer is isotactic. In some embodiments, the thermoelastic polymer is atactic. In some embodiments, the thermoelastic polymer is syndiotactic.

As used herein, a “copolymer” refers to a composition having a repeating structure comprising two or more different repeating units. In some embodiments, a thermoelastic copolymer for use with the present invention comprises a reaction product synthesized from the reaction of two or more different oligomers. Suitable thermoelastic copolymers include, but are not limited to, alternating copolymers, periodic copolymers, random copolymers, statistical copolymers, and block copolymers.

In some embodiments, the thermoelastic polymer is regio-regular block copolymer. In some embodiments, the thermoelastic polymer is a random block copolymer.

In some embodiments, the thermoelastic polymer is chemically inert. As used herein, “inert” refers to a polymer for use with the present invention being substantially free of functional groups, moieties, side groups, and the like capable of reacting with another functional group, moiety, or side group present on another polymer, present on the surface of a substrate, present in the resist composition, and combinations thereof.

In some embodiments, “inert” can further refer to a thermoelastic polymer for use with the present invention lacking functional groups, moieties, side groups, and the like capable of reacting upon irradiation with visible light, ultraviolet light, and combinations thereof. In some embodiments, inertness refers to a thermoelastic polymer that does not undergo substantial chemical change upon exposure to visible light, ultraviolet light, and the like. For example, in some embodiments a resist compositions of the present invention comprises a thermoelastic polymer that does not undergo substantial photochemical reaction (e.g., cross-linking, acid generation, etc.) upon exposure to light having a wavelength of about 190 nm to about 800 nm, about 250 nm to about 800 nm, about 300 nm to about 800 nm, or about 350 nm to about 800 nm. As used herein, “substantial photochemical reaction” refers to a functional group, moiety, and the like that is typically present in a photoresist composition (e.g., a chromophore, a sensitizer, and the like) that undergoes chemical reaction, isomerization, and/or energy transfer upon exposure to electromagnetic radiation. In some embodiments, a film or pattern prepared from a resist composition of the present invention does not undergo substantial acid generation upon exposure to light having a wavelength of about 157 nm, about 193 nm, about 248 nm, about 254 nm, about 350 nm, or about 415 nm. Thus, while “traditional” photoresists can be utilized with the patterning method of the present invention, in some embodiments the present invention is directed to resist compositions comprising a thermoelastic polymer that substantially lacks a chemical functional group designed to absorb light and undergo chemical reaction. It is recognized that many thermoelastic polymers have at least some light absorption in the ultraviolet/visible spectrum, particularly at wavelengths of about 200 nm or less. However, most thermoelastic polymers do not undergo substantial cross-linking and/or acid-generating reactions upon absorption of light; common reactions include, but are not limited to, free-radical generation followed by oxidation, leading to formation of a brittle, non-elastic composition.

In some embodiments, the resist compositions of the present invention comprising a thermoelastic polymer that does not undergo substantial photochemical reaction can be characterized by an absorptivity in the ultraviolet and visible regions of the electromagnetic spectrum. As used herein, an “absorptivity” refers to the absorption of light per unit volume of a film or pattern prepared using a resist composition of the present invention. In some embodiments, a film or pattern prepared from a resist composition of the present invention having a thickness of 100 nm absorbs 10% or less, 8% or less, 5% or less, 2% or less, or 1% or less of radiation having a wavelength of about 250 nm to about 800 nm. In some embodiments, a resist composition of the present invention lacks a light absorbing moiety, functional group, and the like having a peak molar absorptivity of 10,000 M⁻¹cm⁻¹ or more, 5,000 M⁻¹cm⁻¹ or more, 2,000 M⁻¹cm⁻¹ or more, 1,000 M⁻¹cm⁻¹ or more, 500 M⁻¹cm⁻¹ or more, 300 M⁻¹cm⁻¹ or more, 200 M⁻¹cm⁻¹ or more, or 100 M⁻¹cm⁻¹ or more from about 250 nm to about 800 nm. A “peak absorptivity” refers to a maximum absorptivity at a specific wavelength from about 250 nm to about 800 nm.

In some embodiments, the thermoelastic polymer has a molecular weight of 60,000 Da to 130,000 Da. In some embodiments, the thermoelastic polymer has: a maximum molecular weight of 130,000 Da, 125,000 Da, 120,000 Da, 115,000 Da, 110,000 Da, 105,000 Da, 100,000 Da, or 95,000 Da; a minimum molecular weight of 60,000 Da, 65,000 Da, 70,000 Da, 75,000 Da, 80,000 Da, 85,000 Da, 90,000 Da; or a molecular weight within a range proscribed by any of the minimum and maximum molecular weights recited herein (e.g., molecular weight of 60,000 Da to 130,000 Da, 60,000 Da to 125,000 Da, etc.). In some embodiments, the thermoelastic polymer is an 80% ethoxylated polyethyleneimine polymer having a molecular weight of about 70,000 Da, a polystyrene-block-poly(ethylene-ran-butylene)-block-polystyrene polymer having a molecular weight of about 118,000 Da, or a polystyrene-block-poly(ethylene-ran-butylene)-block-polystyrene polymer having a molecular weight of about 89,000 Da.

In some embodiments, the thermoelastic polymer has a Young's Modulus of 20 MPa or less. In some embodiments, the thermoelastic polymer has: a maximum Young's Modulus of 20 MPa, 15 MPa, 10 MPa, 5 MPa, 3 MPa, or 2 MPa; a minimum Young's Modulus of 0.1 MPa, 0.2 MPa, 0.3 MPa, 0.5 MPa, or 1 MPa; or a Young's Modulus within a range proscribed by any of these minimum and maximum Young's Moduli recited herein (e.g., Young's Modulus of 0.1 MPa to 20 MPa, 0.2 MPa to 15 MPa, etc.). In some embodiments, the thermoelastic polymer has a Young's Modulus of 2 MPa to 4 MPa. In some embodiments, the thermoelastic polymer has a Young's Modulus of about 2.4 MPa, about 2.7 MPa, or about 3.4 MPa.

In some embodiments, the thermoelastic polymer has a melting point of 80° C. to 125° C. In some embodiments, the thermoelastic polymer has: a maximum melting point of 125° C., 120° C., 115° C., 110° C., 105° C., or 100° C.; a minimum melting point of 80° C., 85° C., 90° C., 95° C., or 100° C.; or a melting point within a range proscribed by any of these minimum and maximum melting points recited herein (e.g., melting point of 80° C. to 125° C., 90° C. to 110° C., etc.). In some embodiments, the thermoelastic polymer is a poly(styrene-co-butadiene) polymer having a melting point of about 93°-95° C. or a poly(acrylonitrile-co-butadiene-co-styrene) polymer having a melting point of about 95° C.

In some embodiments, the thermoelastic polymer has a T_{g} of about 25° C. or less. In some embodiments, the thermoelastic polymer has a T_{g} of −60° C. to −30° C. In some embodiments, the thermoelastic polymer has a maximum T_{g} of about 25° C., about 20° C., about 15° C., about 10° C., about 0° C., about −10° C., about −20° C., about −30° C., about −35° C., about −40° C., or about −45° C. In some embodiments, the thermoelastic polymer has a minimum T_{g} of about −60° C., about −55° C., about −50° C., or about −45° C. In some embodiments, the thermoelastic polymer is a poly(styrene-co-butadiene) polymer having a T_{g} of about −52° C. or a polystyrene-block-poly(ethylene-ran-butylene)-block-polystyrene polymer having a T_{g} of about −40° C.

In some embodiments, the thermoelastic polymer comprises a first polymer having a T_{g} of about 25° C. or less and a second polymer having a T_{g} of about 25° C. or greater.

In some embodiments, the thermoelastic polymer is present in a concentration of 0.1% to 10% by weight of the resist composition. In some embodiments, the thermoelastic polymer is present in a maximum concentration of about 10%, about 9%, about 8%, about 7%, about 6%, about 5%, about 4%, about 3%, about 2%, or about 1% by weight of the resist composition. In some embodiments, the thermoelastic polymer is present in a minimum concentration of about 0.1%, about 0.2%, about 0.3%, about 0.4%, about 0.5%, about 0.6%, about 0.7%, about 0.8%, about 0.9%, about 1%, or about 2% by weight of the resist composition. In some embodiments, the thermoelastic polymer is present in a concentration of 1% to 4% by weight of the resist composition.

The resist compositions include one or more solvents. Solvents suitable for use with the present invention include both non-polar and polar solvents, including both protic and aprotic solvents. In some embodiments, a solvent is selected based upon the solubility of the thermoelastic polymer in the solvent. For example, in some embodiments a polymer has a solubility of 0.005% by weight or more, 0.01% by weight or more, 0.05% by weight or more, 0.1% by weight or more, 0.5% by weight or more, 1% by weight or more, or 2% by weight or more in a solvent.

Solvents suitable for use with the present invention include, but are not limited to, C₆-C₁₅ straight chain, branched and cyclic hydrocarbons (e.g., hexane, cyclohexane and the like), C₆-C₁₆ aryl and aralkyl hydrocarbons (e.g., benzene, toluene, xylene, and the like), C₁-C₁₅ alkyl, aryl, and aralkyl alcohols (e.g., methanol, ethanol, propanol, butanol, and the like), C₆-C₁₅ alkyl, aryl, and aralkyl amines, C₆-C₁₅ alkyl, aryl, and aralkyl amides (e.g., dimethylformamide, N-methylpyrrolidone, and the like), C₆-C₁₅ alkyl and aralkyl ketones (e.g., acetone, methylethylketone, benzophenone, and the like), C₆-C₁₅ esters (e.g., ethyl acetate and the like), C₆-C₁₅ alkyl and aralkyl ethers (e.g., ethyleneglycol dimethylether and the like), and combinations thereof.

In some embodiments, the solvent is selected from the group consisting of: benzene, toluene, a xylene, cumene, mesitylene, propylene glycol mono-methyl ether, tetrahydrofuran, dodecane, tetralin, pyridine, tetrahydrofuran, acetone, ethylacetate, methylethylketone, methylene chloride, 1,2-dichloroethane, chloroform, chlorobenzene, dimethylformamide, and combinations thereof.

In some embodiments, a solvent is present in an resist composition in a concentration of 10% to 99.9% by weight. In some embodiments, a solvent is present in a resist composition in a maximum concentration of about 99.9%, about 99.5%, about 99%, about 98%, about 97%, about 95%, about 90%, about 80%, about 70%, about 60%, or about 50% by weight. In some embodiments, a solvent is present in a minimum concentration of about 15%, about 20%, about 25%, about 30%, about 40%, about 50%, about 60%, about 70%, or about 80% by weight of the resist composition.

In some embodiments, the solvent has a dielectric constant of 50 or less, 40 or less, 30 or less, 25 or less, or 20 or less.

In some embodiments, the solvent has a boiling point of 35° C. to 200° C. In some embodiments, the solvent has: a maximum boiling point of 200° C., 190° C., 180° C., 170° C., 160° C., 150° C., 140° C., 130° C., 120° C., 110° C., 105° C., 100° C., 95° C., 90° C., 85° C., 80° C., or 75° C.; a minimum boiling point of about 35° C., 40° C., 45° C., 50° C., 55° C., 60° C., 65° C., 70° C., or 75° C.; or a boiling point within a range proscribed by any of the minimum and maximum boiling points recited herein (e.g., boiling point of 50° C. to 200° C., 60° C. to 160° C., etc.).

In some embodiments, a solvent is present in a resist composition in a concentration of 90% to 99.9% by weight. In some embodiments, a solvent is present in a resist composition in: a maximum concentration of 99.9%, 99.98%, 99.7%, 99.5%, 99%, 98%, 97%, or 95% by weight; a minimum concentration of 90%, 91%, 92%, 93%, or 94%, by weight; or in a concentration within a range proscribed by any of the minimum and maximum concentrations recited herein (e.g., a concentration of 93% to 99.5% by weight, etc.).

In some embodiments, the resist composition includes two or more solvents selected based upon at least one of: boiling point, viscosity, polarity, dielectric constant, and chemical functionality (e.g., functional groups).

In some embodiments, the resist composition further includes a surfactant. A surfactant can be added to a resist composition to modify the surface energy of a stamp and/or substrate and improve surface wetting. Surfactants suitable for use with the present invention include, but are not limited to, fluorocarbon surfactants that include an aliphatic fluorocarbon group (e.g., ZONYL® FSA and FSN fluorosurfactants, E.I. Du Pont de Nemours and Co., Wilmington, Del.), fluorinated alkyl alkoxylates (e.g., FLUORAD® surfactants, Minnesota Mining and Manufacturing Co., St. Paul, Minn.), hydrocarbon surfactants that have an aliphatic group (e.g., alkylphenol ethoxylates comprising an alkyl group having 6 to 12 carbon atoms, such as octylphenol ethoxylate, available as TRITON® X-100, Union Carbide, Danbury, Conn.), silicone surfactants such as silanes and siloxanes (e.g., polyoxyethylene-modified polydimethylsiloxanes such as DOW CORNING® Q2-5211 and Q2-5212, Dow Corning Corp., Midland, Mich.), fluorinated silicone surfactants (e.g., fluorinated polysilanes such as LEVELENE® 100, Ecology Chemical Co., Watertown Mass.), and combinations thereof.

In some embodiments, the composition of a resist is formulated to control its viscosity. Parameters that can control resist composition viscosity include, but are not limited to, solvent composition, solvent concentration, polymer length, polymer molecular weight, polymer cross-linking, polymer swellability, ionic interactions between components, and combinations thereof. In some embodiments, the viscosity of a resist composition can be modified for example, by heating, cooling, pH change, and the like.

In some embodiments, a resist composition has a viscosity of 0.5 centiPoise (“cP”) to 10 cP. In some embodiments, a resist composition has a tunable viscosity, and/or a viscosity that can be controlled by one or more external conditions. In some embodiments, the resist composition has: a maximum viscosity of 10 cP, 8 cP, 5 cP, or 2 cP; a minimum viscosity of about 0.5 cP, 0.75 cP, 0.8 cP, 0.9 cP, 1 cP, 1.5 cP; or a viscosity within a range proscribed by any of the minimum and maximum viscosities recited herein (e.g., a viscosity of 0.5 cP to 8 cP, etc.).

Not being bound by any particular theory, the resist compositions of the present invention have a viscosity suitable for uniformly coating a three-dimensional object by, for example, dip coating, spraying, aerosolizing, brushing, spin-coating, ink jet printing, syringe depositing, and the like, and any other coating process known by persons of ordinary skill in the art.

In some embodiments, the resist composition of the present invention is substantially free from particulates. As used herein, “substantially free from” refers to a concentration of particulates (i.e., materials having a particulate morphology) of 1% or less, 0.5% or less, 0.1% or less, 0.05% or less, 0.01% or less, 0.005% or less, or 0.001% or less by weight. As used herein, a “particulate material” refers to a three-dimensional object having a lateral dimension, diameter (e.g., a D₅₀), and the like of 100 nm to 100 μm. In some embodiments, the resist composition of the present invention is substantially free from a particulate having: a maximum lateral dimension or diameter of 25 μm, 20 μm, 10 μm, 5 μm, 2 μm, 1 μm, 750 nm, 500 nm, or 400 nm; a minimum lateral dimension or diameter of 100 nm, 150 nm, 200 nm, 250 nm, 300 nm, 350 nm, 400 nm, 450 nm, or 500 nm; or a lateral dimension or diameter within a range proscribed by any of the minima and maxima recited herein (e.g., a lateral dimension or diameter of 100 nm to 25 μm, etc.).

In some embodiments, the present invention is directed to a resist composition consisting essentially of: a thermoelastic polymer selected from: a styrene-ethylene copolymer, a styrene-ethylene block copolymer, a styrene-ethylene-butylene block copolymer, a styrene-butadiene copolymer, a styrene-butadiene block copolymer, a maleic anhydride-grafted styrene-ethylene block copolymer, a sulfonated styrene-alkylene block copolymer, an acrylonitrile-styrene-ethylene block copolymer, an arylene-vinylene copolymer, a polyethyleneimine polymer, methylmethacrylate-butadiene copolymer, and combinations thereof, wherein the thermoelastic polymer has a Young's Modulus of 20 MPa or less, the thermoelastic polymer has a molecular weight of 60,000 Da to 130,000 Da, and the thermoelastic polymer is present in a concentration of 0.1% to 10% by weight; and one or more solvents having a boiling point of 35° C. to 200° C., and wherein the resist composition is substantially free from particulates.

The present invention is also directed to methods for preparing a resist composition, the methods comprising: providing a thermoelastic polymer; dissolving the thermoelastic polymer in one or more solvents to produce a solution, filtering the solution, and placing the solution in a sealable container.

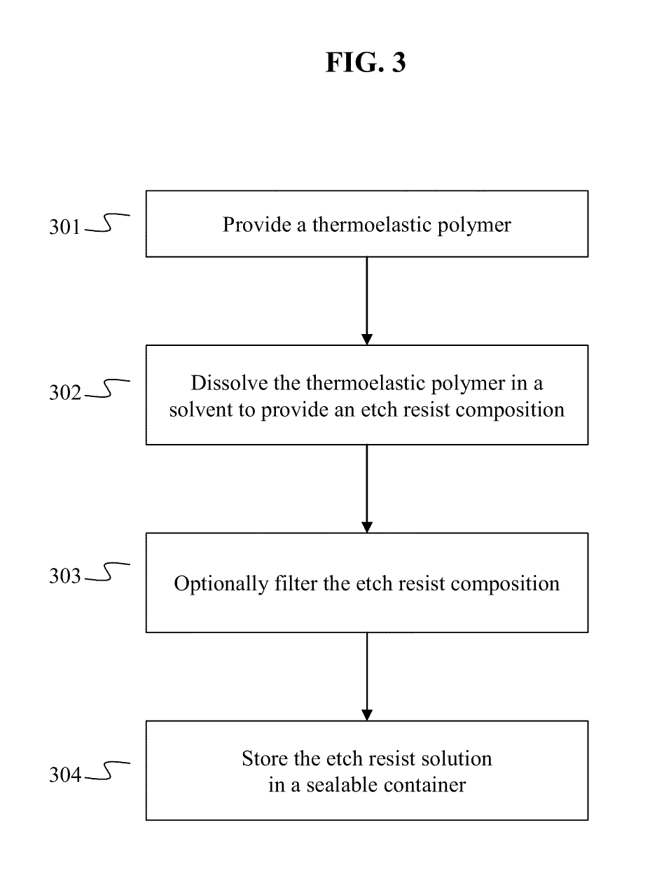

Referring to FIG. 3, a method of the present invention comprises providing a thermoelastic copolymer, as indicated by block 301. The thermoelastic polymer is dissolved in a solvent, 302. The dissolving, 302, can further comprise optional heating, stirring, agitating, and/or sonicating processes, or optionally adding a surfactant, acid, base, or salt to the solvent and/or composition.

The solution is then optionally filtered, 303. Filtering can be performed using a porous and/or microporous membrane, a wire mesh, paper, fitted glass, and the like, and other permeable and semi-permeable materials known to persons of ordinary skill in the art. In some embodiments, the filtering material has a pore size of 5 nm to 1 μm. In some embodiments, the filtering material has: a maximum pore size of 1 μm, 900 nm, 800 nm, 700 nm, 600 nm, 500 nm, 400 nm, 300 nm, 200 nm, or 100 nm; a minimum pore size of 5 nm, 10 nm, 15 nm, 20 nm, 50 nm, 100 nm, 150 nm, or 200 nm; or a pore within a range proscribed by any of the minima and maxima recited herein (e.g., a pore size of 5 nm to 900 nm, etc.).

The resist composition is stored in a sealed container, 304. The container is non-permeable and unreactive towards the resist composition. In some embodiments, the container is impermeable to light.

### Methods

The methods of the present invention are generally applicable to use with a wide variety of resists, and the methods are in no way limited by the resist compositions described herein. Thus, the present invention is also directed to a method for forming a feature on a substrate, the method comprising:
applying a resist composition comprising a thermoelastic polymer to a surface of a stamp to provide a coated stamp, wherein the stamp comprises a flexible material and the stamp surface includes at least one indentation therein, the indentation being contiguous with and defining a pattern in the surface of the stamp;
contacting the coated stamp with a substrate for an amount of time and at a temperature sufficient to transfer the thermoelastic polymer from the stamp surface to the substrate, wherein the thermoelastic polymer covers the substrate in a pattern according to the pattern in the surface of the stamp;
separating the stamp from the substrate; and
reacting an area of the substrate not covered by the thermoelastic polymer pattern to a reactive composition to form a feature thereon,
wherein the pattern in the surface of the stamp defines a lateral dimension of the feature.

As used herein, a “stamp” refers to a three-dimensional object having on at least one surface thereof an indentation that defines a pattern. Stamps for use with the present invention are not particularly limited by geometry, and can be flat, curved, smooth, rough, wavy, and combinations thereof. In some embodiments, a stamp can have a three dimensional shape suitable for conformally contacting a substrate. The stamps of the present invention are distinguishable from stencils in that stencils include a surface having one or more openings there through, as opposed to an indentation in a surface of a stamp.

In some embodiments, a stamp can comprise multiple patterned surfaces that comprise the same, or different patterns. In some embodiments, a stamp comprises a cylinder wherein one or more indentations in the curved face of the cylinder define a pattern. As the cylindrical stamp is rolled across a substrate, the pattern is repeated. A resist composition can be applied to a cylindrical stamp as it rotates. For stamps having multiple patterned surfaces: cleaning, applying, contacting, removing, and reacting steps can occur simultaneously on the different surfaces of the same stamp.

In some embodiments, a stamp comprises a flexible material. As used herein, “flexible” refers to a material capable of being flexed, or undergoing elastic or plastic deformation, bending, compression, twisting, and the like in response to applied external force, stress, strain and/or torsion. In some embodiments, a flexible material is capable of being rolled upon itself. Preferred flexible materials for use with a stamp of the present invention include elastomeric polymers, i.e., “elastomers”. Elastomers suitable for use as a materials in a stamp include, but are not limited to, a polyurethane, a resilin, an elastin, a polyimide, a phenol formaldehyde polymer, a polydialkylsiloxane (e.g., polydimethylsiloxane, “PDMS”), a natural rubber, a polyisoprene, a butyl rubber, a halogenated butyl rubber, a polybutadiene, a styrene butadiene, a nitrile rubber, a hydrated nitrile rubber, a chloroprene rubber (e.g., polychloroprene, available as NEOPRENE™ and BAYPREN®, Farbenfabriken Bayer AG Corp., Leverkusen-Bayerwerk, Germany), an ethylene propylene rubber, an epichlorohydrin rubber, a polyacrylic rubber, a silicone rubber, a fluorosilicone rubber, a fluoroelastomer (for example, those described herein, supra), a perfluoroelastomer, a tetrafluoroethylene/propylene rubber, a chlorosulfonated polyethylene, an ethylene vinyl acetate, cross-linked variants thereof, halogenated variants thereof, and combinations thereof.

Stamps and materials suitable for use with the present invention are also described in U.S. Pat. Nos. 5,512,131; 5,900,160; 6,180,239; 6,355,198 and 6,776,094, all of with are incorporated herein by reference in their entirety. A flexible material suitable for use with a stamp of the present invention should be compatible with a resist composition. Compatibility considerations include, but are not limited to, transparency, solubility, swellability, and thermal stability.

In some embodiments, a flexible material is transparent to one or more wavelengths of electromagnetic radiation selected from the ultraviolet, visible, infrared, and microwave regions of the electromagnetic spectrum.

In some embodiments, a flexible material and/or a material included in a surface of a stamp of the present invention has a minimal solubility in a resist composition, or in a solvent that is a component of a resist composition. For example, a flexible material and/or a material included in a surface of a stamp can have a solubility of about 1% or less, about 0.1% or less, about 100 ppm or less, or about 10 ppm or less, by weight, in a resist composition, or in a solvent that is present in a resist composition.

In some embodiments, a stamp of the present invention undergoes a minimal swelling upon coating with a resist composition. For example, a stamp can undergo a volume increase of 10% or less, 5% or less, 2% or less, or 1% or less after coating with a resist composition.

A stamp of the present invention is thermally stable. For example, in some embodiments a stamp of the present invention undergoes a weight loss of 5% or less, 2% or less, or 1% or less upon heating to a temperature of 100° C. or more, 120° C. or more, or 150° C. or more. In some embodiments, a stamp of the present invention undergoes a swelling (i.e., volume increase) of 10% or less, 5% or less, 2% or less, or 1% or less upon heating to a temperature of 100° C. or more, 120° C. or more, or 150° C. or more.

In some embodiments, a stamp further comprises a stiff, rigid, flexible, porous, or woven backing material, or any other means of preventing deformation of the stamp during the patterning processes described herein.

The at least one indentation in the surface of the stamp can be of any shape or geometry. For example, the at least one indentation can have a rectilinear, curved, hemispherical and/or inverted pyramid shape, and the like, or any other three-dimensional shape known to persons of ordinary skill in the art. In some embodiments, the at least one indentation has at the base of the indentation a flat surface substantially parallel to or concentric with the stamp surface. In some embodiments, the at least one indentation comprises a sidewall that can form an acute or obtuse angle with the stamp surface or be oriented orthogonal to the stamp surface.

In some embodiments, a pattern in the surface of the stamp has at least one lateral dimension of 50 μm or less, 25 μm or less, 20 μm or less, 15 μm or less, 10 μm or less, 5 μm or less, 2 μm or less, or 1 μm or less.

Stamps for use with the present invention can optionally include a derivatized surface comprising, e.g., a non-polar functional group, a polar functional group, a metal, and combinations thereof. Stamps for use with the present invention can optionally include a surface coating thereon, such as, but not limited to, a metal, a high-density elastomer, a plastic, and combinations thereof.

Not being bound by any particular theory, the area of the stamp surface that does not have at least one indentation formed therein provides the surface of the stamp that forms the thermoelastic polymer pattern on a substrate. After a thermoelastic polymer pattern is formed, a surface feature is formed on the substrate having lateral dimensions that substantially conform to the lateral dimensions of the at least one indentation in the stamp surface. Thus, the pattern formed by the at least one indentation in the stamp surface is substantially identical to a pattern formed by a feature on a substrate by the methods of the present invention.

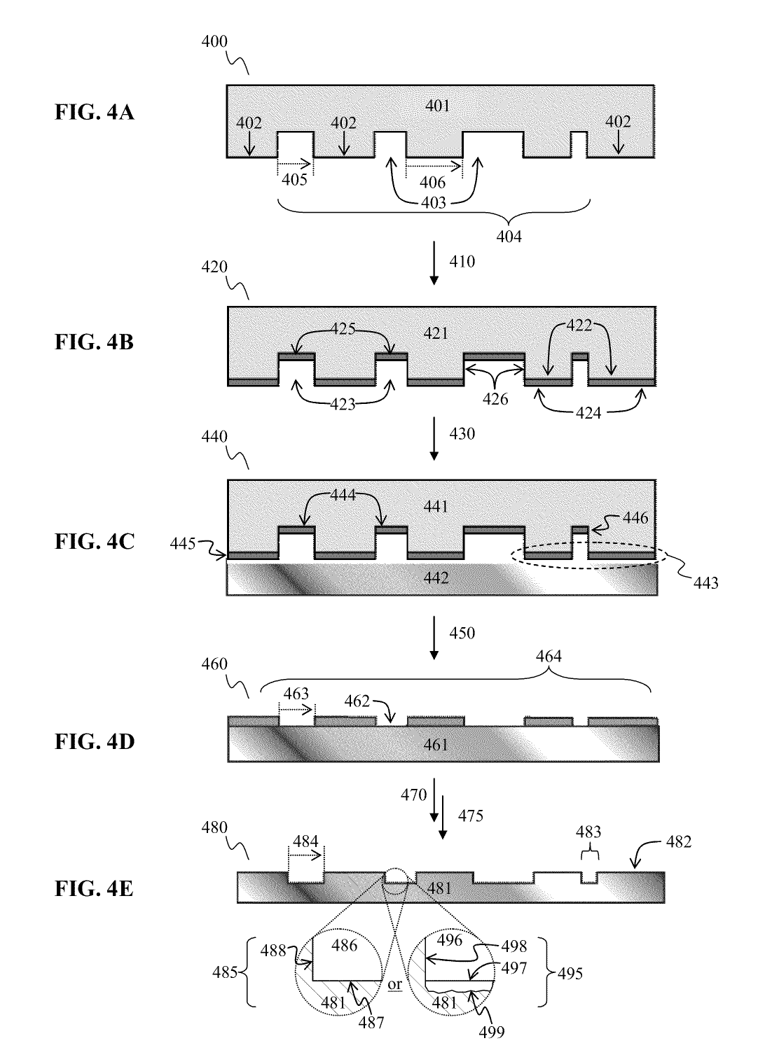

FIGS. 4A-4D provide schematic cross-sectional representations of embodiments of a process of the present invention. Referring to FIG. 4A, a stamp, 400, is provided comprising a flexible material, 401, the stamp including a surface, 402, having at least one indentation therein, 403, forming a pattern, 404, in the surface of the stamp. In some embodiments, the at least one indentation, 403, has at least one lateral dimension, 405, of 50 μm or less. In some embodiments, the surface of the stamp, 402, has at least one lateral dimension, 406, separating adjacent indentations, 403, of 50 μm or less. A resist composition is then applied, 410, to the surface of the stamp to provide a coated stamp.

Referring to FIG. 4B, a coated stamp composition, 420, is provided comprising a stamp, 421, having a surface, 422, including at least one indentation therein, 423. The surface of the stamp, 422, is coated with a resist composition comprising a thermoelastic polymer, 424. In some embodiments, the resist composition also at least partially coats or fills the at least one indentation, 425. In some embodiments, a sidewall of the at least one indentation, 426, is substantially free from the resist composition. Thus, in some embodiments the resist composition forms a discontinuous coating on the surface of the stamp in which a discontinuity is present at the at least one indentation. The thickness of the resist composition across the stamp surface is substantially uniform. Various methods can be used to ensure a resist composition is of substantially uniform thickness across the entire surface of a stamp. For example, in some embodiments, the method further comprises pre-treating at least a portion of the stamp surface prior to the applying.

The coated stamp composition is then contacted with a substrate, 430, for an amount of time and at a temperature sufficient to transfer the thermoelastic polymer from the stamp surface to the substrate.

Referring to FIG. 4C, a composition, 440, comprising a coated stamp, 441, in contact, 443, with a substrate, 442, is provided. The stamp and substrate are contacted for an amount of time and/or under conditions sufficient to transfer the thermoelastic polymer from the stamp to the substrate. The at least one indentation, 444, in the surface of the stamp does not contact the substrate. Furthermore, a thermoelastic polymer, 446, if present in the at least one indentation, also does not contact the substrate. Thus, only the thermoelastic polymer present on the surface of the stamp, 445, is transferred to the substrate. The stamp and substrate are then separated, 450.

Referring to FIG. 4D, a composition comprising a thermoelastic polymer pattern, 464, on a substrate, 461, is provided. At least a portion of the substrate, 462, is not covered by thermoelastic polymer pattern. The thermoelastic polymer pattern has a spacing, 463. In some embodiments, the pattern spacing, 463, has at least one lateral dimension of 50 μm or less. The substrate is then reacted, 470, with a reactive composition to provide a feature on the substrate, 470, and the thermoelastic polymer pattern is then removed, 475, from the substrate.

Referring to FIG. 4E, a composition, 480, comprising a substrate, 481, having a feature, 483, thereon is provided. The thermoelastic polymer has been removed from the substrate surface, 482. The feature, 483, has at least one lateral dimension, 484, of 50 μm or less. In some embodiments, the feature, 483, is a subtractive non-penetrating feature or a subtractive penetrating feature. For example, referring to inset, 485, an area of a substrate occupied by a subtractive non-penetrating feature, 486, is provided. The substrate, 481, forms the boundaries of the feature, including a base, 487, and a sidewall, 488. The feature is non-penetrating and thus the region of the substrate underlying the base of the feature is substantially similar to the body of the substrate.

Referring to inset, 495, an area of a substrate occupied by a subtractive penetrating feature, 496, is provided. The substrate, 481, forms the boundaries of the sidewall of the feature, 498. The feature comprises a base, 497, having a first elevation and a further comprises an inset region, 499, which penetrates into the substrate.

The resist composition can be applied to a stamp surface by a coating method known in the art such as, but not limited to, screen printing, ink jet printing, syringe deposition, spraying, spin coating, brushing, atomizing, dipping, aerosol depositing, capillary wicking, and combinations thereof. In some embodiments, applying a resist composition to a stamp surface comprises spin coating (i.e., rotating the stamp surface at about 100 revolutions per minute (rpm) to about 5,000 rpm while pouring or spraying the resist composition onto the stamp surface).

In some embodiments, the viscosity of a resist composition is modified during one or more of an applying step, contacting step, annealing step, reacting step, or combinations thereof. For example, the stamp surface can be exposed to heating and cooling cycles to modify the viscosity of a resist composition during the applying, contacting, and/or reacting steps. In some embodiments, the resist composition undergoes a phase transition during one or more of an applying step, contacting step, annealing step, reacting step, or combinations thereof.

In some embodiments, the method of the present invention further comprises annealing the resist composition or the thermoelastic polymer. As used herein, “annealing” refers to applying thermal energy to, removing a solvent from, and/or chemically treating a resist composition that has been applied to a stamp or a substrate. An annealing can be performed after applying the resist composition to the stamp surface and/or after contacting the coated stamp

The contacting is performed for an amount of time sufficient to transfer the thermoelastic polymer from a surface of the coated stamp to the substrate. In some embodiments, the contacting is for a period of 0.5 seconds to 80 seconds, 1 second to 80 seconds, 5 seconds to 75 seconds, 10 seconds to 70 seconds, 15 seconds to 60 seconds, at least 1 second, at least 2 seconds, at least 5 seconds, at least 10 seconds, at least 20 seconds, or at least 30 seconds. In some embodiments, the contacting is performed for 80 seconds or less, 60 seconds or less, 30 seconds or less, 20 seconds or less, 15 seconds or less, 10 seconds or less, 5 seconds or less, or 1 second or less.

The contacting transfers the thermoelastic polymer from the stamp surface to the substrate and can be promoted by one or more interactions between the thermoelastic polymer and the stamp, between the thermoelastic polymer and the substrate, between the stamp and the substrate, and combinations thereof that promote adhesion of a thin film of a thermoelastic polymer to an area of a substrate. Not being bound by any particular theory, adhesion of a thin film of a thermoelastic polymer to an area of a substrate can be promoted by gravity, a Van der Waals interaction, a covalent bond, an ionic interaction, a hydrogen bond, a hydrophilic interaction, a hydrophobic interaction, a magnetic interaction, and combinations thereof. Conversely, the minimization of these interactions between a thin film of thermoelastic polymer and the surface of a stamp can facilitate transfer of the thermoelastic polymer from the stamp to the substrate.

The contacting is performed under conditions sufficient to transfer the thermoelastic polymer from a surface of the coated stamp to the substrate. In some embodiments, the thermoelastic polymer is maintained in a viscous, semi-viscous, tacky, elastic, or otherwise flexible state during the contacting. In some embodiments, maintaining the thermoelastic polymer in a viscous, semi-viscous, tacky, elastic, or otherwise flexible state can be done by maintaining a solvent in the resist composition. However, in some embodiments it can be desirable to remove a solvent from a resist composition prior to the contacting due to any of the following concerns: solvent containment, solvent disposal, solvent cost, possible loss of feature size (induced by, e.g., solvent-induced swelling of a stamp), and combinations thereof. A solvent-less method suitable for maintaining the thermoelastic polymer in a viscous, semi-viscous, tacky, elastic, or otherwise flexible state, and to facilitate transfer of the thermoelastic polymer from the stamp surface to the substrate is by applying thermal energy to any of the stamp, the polymer, the substrate, and combinations thereof. In addition to facilitating transfer of the thermoelastic polymer pattern from the stamp surface to a substrate, in some embodiments the application of thermal energy to any of the stamp, the polymer, the substrate, and combinations thereof can reduce the rate of defects and generally improve the overall reproducibility of the method of the present invention.

The temperature at which any of the stamp, the polymer, the substrate, and combinations thereof can be heated during at least the contacting can vary depending on, e.g., the properties and of the thermoelastic polymer and the surface area of the pattern. In some embodiments, the contacting further comprises heating the substrate, the stamp, the resist composition, or a combination thereof to a temperature above the T_{g} of the thermoelastic polymer or to a temperature above the T_{g} of the mixture of thermoelastic polymers present in the resist composition. In some embodiments, the contacting further comprises heating the substrate, the stamp, the resist composition, or a combination thereof to a temperature of 30° C. to 150° C., 40° C. to 140° C., 50° C. to 130° C., 60° C. to 120° C., 50° C. to 100° C., 60° C. to 95° C., 70° C. to 90° C., 90° C., 85° C. or 80° C.

Non-limiting methods for heating the substrate, the stamp, the resist composition, or a combination thereof include contacting the substrate and/or the stamp with a heating element; resistively heating the substrate, a backing layer of the stamp, a contact layer of the stamp, and the like; irradiating the stamp, substrate, or a component present in the resist composition with UV, visible and/or IR radiation; convective heating; and combinations thereof; as well as via any other heating methods known to persons of ordinary skill in the art.

In some embodiments, the stamp surface and the substrate do not physically contact each other during the contacting. Not being bound by any particular theory, transfer of the thermoelastic polymer from the stamp to the substrate can occur via an adhesive interaction with the substrate that is stronger than an adhesive interaction between the polymer and the surface of the stamp.

The present invention also optimizes the performance, efficiency, cost, and speed of the process steps by selecting inks, stamps and substrates that are compatible with one another. For example, in some embodiments, a substrate or a stamp is selected based upon its optical transmission properties, thermal conductivity, electrical conductivity, and combinations thereof.

In some embodiments, the substrate and/or the surface of a stamp can be selectively patterned, functionalized, derivatized, textured, or otherwise pre-treated in a to increase an adhesive interaction between a resist composition and the substrate and/or stamp surface. As used herein, “pre-treating” refers to chemically or physically modifying a surface prior to any one of the applying, the contacting, or the reacting. Pre-treating can include, but is not limited to, cleaning, oxidizing, reducing, derivatizing, functionalizing, as well as exposing a substrate to any one of: a reactive gas, an oxidizing plasma, a reducing plasma, a thermal energy, an ultraviolet radiation, a visible radiation, an infrared radiation, and combinations thereof.

In some embodiments, pre-treating the substrate comprises depositing a contact layer onto the substrate. As used herein, a “contact layer” refers to a thin film, self-assembled monolayer, and the like, and combinations thereof capable of increasing an adhesive force between a substrate and a thermoelastic polymer. In some embodiments, the depositing a contact layer comprises depositing a self-assembled monolayer.

For example, a substrate can be pre-treated by applying an a self-assembled monolayer (“SAM”) pattern to the substrate using a stamp. A SAM-forming species can be transferred from a stamp to the substrate to form a first pattern comprising at least one of a thin film, a monolayer, a bilayer, and combinations thereof. In some embodiments the SAM-forming species can react with the substrate. A resist composition of the present invention can then be applied to the pre-treated substrate by a contact printing method of the present invention, wherein the resist composition patterns either one of an exposed area of the substrate or an area of the substrate coated by the first pattern. After forming a thermoelastic polymer pattern, the pre-treated substrate can be reacted with a reactive composition.

Not being bound by any particular theory, pre-treating a substrate can increase or decrease an adhesive interaction between a thermoelastic polymer and the substrate. For example, derivatizing a stamp surface with a non-polar functional group can promote wetting of the stamp surface by a resist composition. In some embodiments, pre-treating a stamp surface can prevent a resist composition from penetrating into the body of a stamp. Additionally, derivatizing a substrate with a polar functional group (e.g., oxidizing a surface of the substrate) can promote the wetting of a substrate by a hydrophilic thermoelastic polymer and deter surface wetting by a hydrophobic thermoelastic polymer. In some embodiments, pre-treating a substrate can ensure uniform patterning, and facilitate the formation of features having at least one lateral dimension of 50 μm or less.

In some embodiments, the contacting further comprises applying pressure or vacuum to the backside of either or both the stamp and/or the substrate. In some embodiments, the application of pressure or vacuum can ensure that the resist composition is transferred uniformly from the stamp surface to the substrate. In some embodiments, applying pressure or vacuum can ensure uniform contact between the stamp and substrate surfaces and/or minimize the presence of gas bubbles and the like than can be present between the stamp and substrate surfaces. In some embodiments, a pressure of 5 pounds/in² (psi) to 2,000 psi, 5 psi to 1,500 psi, 5 psi to 1,000 psi, 5 psi to 750 psi, 5 psi to 500 psi, 5 psi to 250 psi, 5 psi to 100 psi, 5 psi to 50 psi, 10 psi to 100 psi, 10 psi to 50 psi, 20 psi to 100 psi, 20 psi to 50 psi, 50 psi to 100 psi, about 50 psi, about 20 psi, about 10 psi, or about 5 psi is applied to the backside of the stamp and/or substrate during the contacting.

In some embodiments, the substrate, the stamp and/or the thermoelastic polymer pattern is cooled prior to separating the stamp from the substrate or prior to the reacting. For example, the substrate, the stamp and/or the thermoelastic polymer pattern can be cooled to a temperature of 50° C. or less, 40° C. or less, 30° C. or less, 25° C. or less, or 20° C. or less prior to the separating. In some embodiments, the substrate, the stamp and/or the thermoelastic polymer pattern can be cooled to a temperature below a glass transition temperature of a thermoelastic polymer present in the pattern on the substrate. Not being bound by any particular theory, cooling the stamp, substrate and/or thermoelastic polymer pattern prior to the separating or prior to the reacting can help to ensure reproducible features are produced with the desired lateral dimensions. For example, cooling the stamp prior to the reacting can ensure that the lateral dimensions of the pattern on the substrate do not change prior to or during the reacting.

The methods of the present invention produce features by reacting a reactive composition with an area of a substrate not covered by the thermoelastic polymer pattern. As used herein, “reacting” refers to initiating a chemical reaction comprising at least one of: reacting one or more components of a reactive composition with a substrate, reacting one or more components of a reactive composition with a sub-surface region of a substrate, reacting two or more components of a reactive composition with each other to generate a reactive species suitable for chemically modifying the substrate, and combinations thereof.

As used herein, a “reactive composition” refers to a composition that includes a compound, species, element, moiety, and the like that can chemically interact (i.e., react) with a substrate, or a generate a species capable of reacting with a substrate. In some embodiments, a reactive composition can penetrate or diffuse into the body of a substrate beneath its surface. In some embodiments, a reactive composition transforms, binds, and/or promotes binding to exposed functional groups on the surface of a substrate or within the body of a substrate. Reactive compositions can include, but are not limited to, acids, bases, halogen-containing compounds, halides, ions, free radicals, metals, metal salts, organic reagents, and combinations thereof.

In some embodiments, a reactive composition can react with a substrate to remove a portion of the substrate. Thus, in some embodiments a reactive composition can form a subtractive feature on a substrate by reacting with a substrate to forms at least one of a volatile material that can diffuse away from the substrate, or a residue, particulate, or fragment that can be removed from the substrate by, for example, a rinsing or cleaning process.

In some embodiments, the thermoelastic polymer patterns of the present invention are resistant to reactive composition. As used herein, a “resistant” thermoelastic polymer refers to a polymer that is removed, degraded and/or chemically modified at a substantially reduced rates compared to an underlying substrate upon exposure to a reactive chemical species such as an etchant. In some embodiments, a resistant thermoelastic polymer comprises a polymer that prevents an area of an underlying substrate having a thermoelastic polymer pattern thereon from reacting with a reactive composition that is applied to the patterned substrate.

As used herein, an “etchant” refers to a composition that includes a compound, ion, species, element, and the like that can chemically react with a substrate to produce a volatile or soluble material that can be removed from the substrate. The resist compositions of the present invention are resistant to commercially available wet and dry etchants such as, but not limited to, phosphoric acid, sulfuric acid, trifluoromethanesulfonic acid, fluorosulfonic acid, trifluoroacetic acid, hydrofluoric acid, hydrochloric acid, FeCl₃/HCl, carborane acid, sodium hydroxide, potassium hydroxide, ammonium hydroxide, tetraalkylammonium hydroxide ammonia, ethanolamine, ethylenediamine, iodine, KI/I₂, chlorine, ammonium fluoride, lithium fluoride, sodium fluoride, potassium fluoride, rubidium fluoride, cesium fluoride, francium fluoride, antimony fluoride, calcium fluoride, ammonium tetrafluoroborate, potassium tetrafluoroborate, and combinations thereof, and solutions thereof.

In some embodiments a reactive composition includes a species selected from an acid, a base, a halogen-containing compound, a halide, and the like, and combinations thereof. Non-limiting examples of acids suitable for use with the present invention include: sulfuric acid, trifluoromethanesulfonic acid, fluorosulfonic acid, trifluoroacetic acid, hydrofluoric acid, hydrochloric acid, carborane acid, and the like, and combinations thereof, and any other acids known to persons of ordinary skill in the art.

Non-limiting examples of bases suitable for use with the present invention include: sodium hydroxide, potassium hydroxide, ammonium hydroxide, tetraalkylammonium hydroxide ammonia, ethanolamine, ethylenediamine, and the like, and combinations thereof, and any other bases known to persons of ordinary skill in the art.

Non-limiting examples of halogen-containing compounds and halides suitable for use with the present invention include: iodine, chlorine, ammonium fluoride, lithium fluoride, sodium fluoride, potassium fluoride, rubidium fluoride, cesium fluoride, francium fluoride, antimony fluoride, calcium fluoride, ammonium tetrafluoroborate, potassium tetrafluoroborate, and the like, and combinations thereof, and any other halogen-containing compounds and halides known to persons of ordinary skill in the art.

In some embodiments, reacting comprises applying a reactive composition to a substrate (i.e., a reaction is initiated upon contact between a reactive composition and a substrate). In some embodiments, a chemical reaction is initiated between a reactive composition and a functional group on the surface of a substrate, or between a reactive composition and a functional group below the surface of the substrate. Thus, methods of the present invention comprise reacting a reactive composition or a component of a reactive composition not only with a surface of a substrate, but also with a sub-surface region of a substrate, thereby forming an inset or inlaid feature in a substrate. Not being bound by any particular theory, a component of a reactive composition can react with a substrate by reacting on its surface, or penetrating and/or diffusing into the substrate. In some embodiments, the penetration of a reactive composition into a substrate can be facilitated by the application of physical pressure or vacuum to the backside of a stamp and/or the substrate.

Reaction between a reactive composition and a substrate can modify one or more properties of substrate, wherein the change in properties is localized to the portion of the substrate that reacts with the reactive composition. For example, a reactive metal particle can penetrate into a substrate, and upon reacting with the substrate, modify its conductivity. In some embodiments, a reactive component can penetrate into a substrate and react selectively to increase the porosity of the substrate in the areas (volumes) where reaction occurs. In some embodiments, a reactive component can selectively react with a crystalline substrate to increase or decrease its volume, or change the interstitial spacing of a crystalline lattice.

In some embodiments, reacting a reactive composition comprises chemically reacting an exposed functional group on a substrate with a component of the reactive composition. Not being bound by any particular theory, a reactive composition containing a reactive component can also react with only the surface of a substrate (i.e., no penetration and reaction occurs into a substrate). In some embodiments, a patterning method wherein only the surface of a substrate is changed can be useful for subsequent self-aligned deposition reactions.

In some embodiments, reacting a reactive composition with a substrate comprises reactions that propagate into the plane of a substrate, as well as reactions in the lateral plane of a substrate. For example, a reaction between an etchant and a substrate can comprise the etchant penetrating into the substrate in the vertical direction (i.e., orthogonally to the substrate), such that the lateral dimensions of the lowest point of a feature formed therefrom are approximately equal to the dimensions of the feature at the plane of the substrate.

In some embodiments, the substrate is maintained at a temperature of 30° C. to 150° C., 40° C. to 140° C., 50° C. to 130° C., 60° C. to 120° C., 50° C. to 100° C., 60° C. to 95° C., 70° C. to 90° C., about 90° C., about 85° C., or about 80° C. during the reacting.

In some embodiments, reacting comprises exposing a reactive composition to a reaction initiator. A reaction initiator can be applied to a substrate before, during, and/or after a reactive composition is applied to the substrate. Alternatively, a reaction initiator can be applied to a reactive composition before, during, and/or after the reactive composition is applied to a substrate. Reaction initiators suitable for use with the present invention include, but are not limited to, thermal energy, radiation, acoustic waves, an oxidizing or reducing plasma, an electron beam, a stoichiometric chemical reagent, a catalytic chemical reagent, an oxidizing or reducing reactive gas, an acid or a base (e.g., a decrease or increase in pH), an increase or decrease in pressure, an alternating or direct electrical current, agitation, sonication, friction, and combinations thereof. In some embodiments, reacting comprises exposing a reactive composition to multiple reaction initiators.

Radiation suitable for use as a reaction initiator can include, but is not limited to, electromagnetic radiation, such as microwave light, infrared light, visible light, ultraviolet light, x-rays, radiofrequency, and combinations thereof.

In some embodiments, the methods of the present invention further comprises removing the thermoelastic polymer pattern from the substrate. The thermoelastic polymer pattern can be removed from the substrate by dissolving the thermoelastic polymer in a solvent; peeling, scraping, abrading, or otherwise mechanically removing the thermoelastic polymer from the substrate; chemically stripping the thermoelastic polymer from the substrate, and the like, and combinations thereof, and any other removal processes known to persons of ordinary skill in the art.

### Stamp-Resist Compositions

The present invention is also directed to a composition comprising: a stamp comprising a flexible material, the stamp having a surface including at least one indentation therein, the indentation being contiguous with and defining a pattern in the surface of the stamp, and having on the surface a polymer composition comprising a thermoelastic polymer, wherein the thermoelastic polymer has a Young's Modulus of 20 MPa or less, and has a molecular weight of 60,000 Da to 130,000 Da.

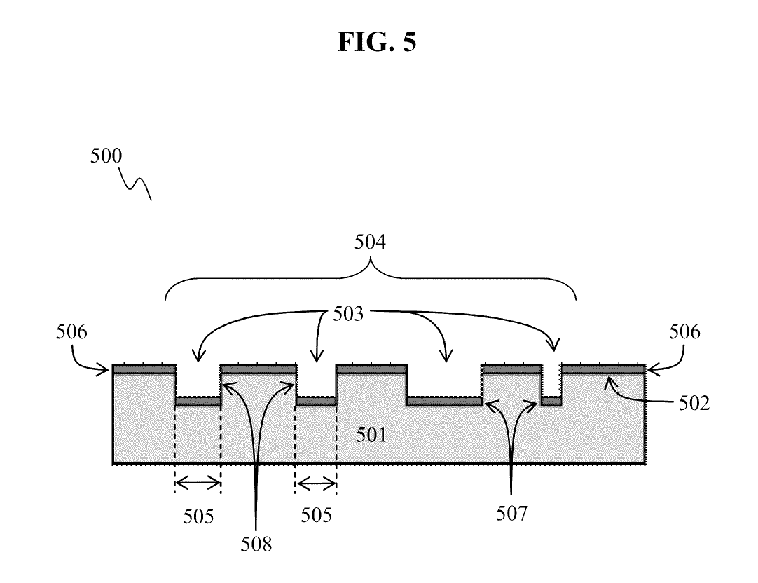

FIG. 5 provides a schematic cross-sectional representation, 500, of a stamp-resist composition of the present invention. Referring to FIG. 5, a stamp, 501, having a surface, 502, and at least one indentation therein, 503, defining a pattern, 504, in the surface of the stamp is provided. The at least one indentation has a lateral dimension, 505. A resist composition, 506, coats at least a portion of the stamp surface. In some embodiments, the resist composition also coats at least a portion of the at least one indentation in the stamp surface, 507. In some embodiments, the resist composition conformally coats at least a portion of the stamp surface. Alternatively, the resist composition can be substantially absent from a sidewall of the at least one indentation, 508.

In some embodiments, the stamp is substantially impermeable to the resist composition. As used herein, “permeability” refers to the tendency of a resist composition to become absorbed by a stamp. A “substantially impermeable” stamp absorbs 10% or less, 5% or less, 2% or less, or 1% or less by volume of a resist composition of the present invention.

Not being bound by any particular theory, the swelling of a stamp can be used as an indirect measure of the permeability of a stamp to a resist composition. Thus, in some embodiments a substantially impermeable stamp undergoes a volume increase of 10% or less, 5% or less, 2% or less, or 1% or less when contacted with a resist composition of the present invention.

In a preferred embodiment, the resist composition coats at least the stamp surface in a substantially uniform manner. As used herein, a “substantially uniform coating of a resist composition on a surface of the stamp” refers to a variation in the thickness of the resist coating on the stamp surface varying by 10% or less, 5% or less, or 2% or less across the surface of the stamp. Not being bound by any particular theory, non-uniform application of the resist composition to the stamp can result in a failure to correctly and reproducibly produce features having the desired lateral dimensions.

In some embodiments, the resist composition forms a discontinuous coating on the stamp surface. As used herein, a “discontinuous coating” of a resist composition on a stamp surface refers to a resist coating that is not conformal. More particularly, a “discontinuous coating” of a resist composition on a stamp surface refers to a coating in which at least a portion of the at least one indentation in the stamp surface is substantially free from a resist composition. For example, a discontinuous coating can be a coating on a stamp in which at least the sidewalls of the at least one indentation are substantially free a resist composition, or a coating in which the at least one indentation is substantially free from a resist composition.

Not being bound by any particular theory, a discontinuous coating of a resist composition on a stamp surface can ensure that only a thermoelastic polymer on the surface of the stamp is transferred from the stamp to a substrate and that portions of a resist composition present in or on the at least one indentation of the stamp are not transferred from the stamp to a substrate.

In some embodiments, the coating of a resist composition on a stamp surface has a thickness of 25 nm to 10 μm, 50 nm to 5 μm, 100 nm to 2 μm, 120 nm to 1 μm, 150 nm to 750 nm, 180 nm to 600 nm, 200 nm to 500 nm, about 100 nm, about 150 nm, about 200 nm, about 250 nm, about 300 nm, about 350 nm, about 400 nm, or about 450 nm.

### Substrate-Resist Compositions

The present invention is also directed to a composition comprising: a substrate having a surface, and on the surface a pattern comprising a thermoelastic polymer, wherein the pattern has at least one spacing of 50 μm or less, the thermoelastic polymer has a Young's Modulus of 20 MPa or less, wherein a film or pattern prepared from the resist composition having a thickness of 100 nm absorbs 10% or less of radiation having a wavelength of about 250 nm to about 800 nm, and the thermoelastic polymer has a molecular weight of 60,000 Da to 130,000 Da.

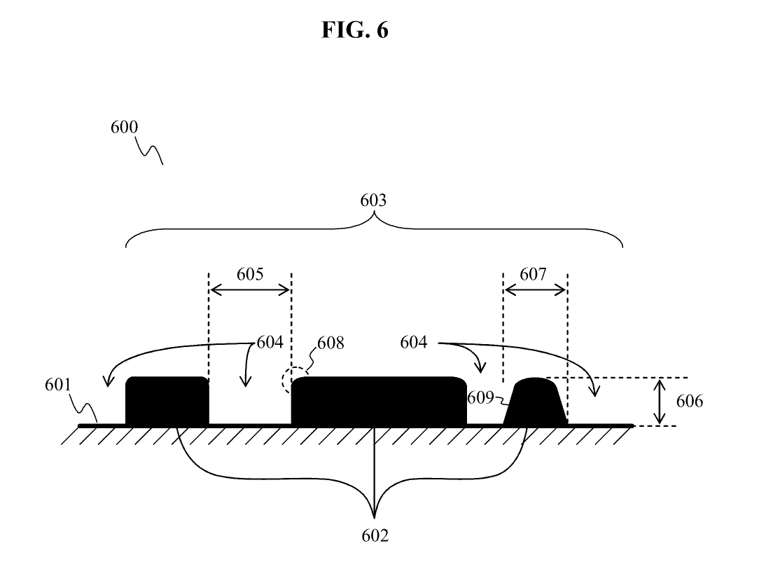

Referring to FIG. 6, a cross-sectional representation of a composition, 600, comprising a substrate, 601, having a thermoelastic polymer, 602, forming a pattern, 603, thereon. At least a portion of the substrate, 604, is not covered by the pattern comprising a thermoelastic polymer. The thermoelastic polymer pattern has at least one spacing, 605, of 50 μm or less. The thermoelastic polymer pattern, 602, also has a vertical dimension, or elevation, 606. The thermoelastic polymer pattern can also be defined by a lateral dimension, 607. In some embodiments, the thermoelastic polymer pattern, 602, has a rounded edge, 608. In some embodiments, the thermoelastic polymer pattern, 602, has an angled sidewall, 609.

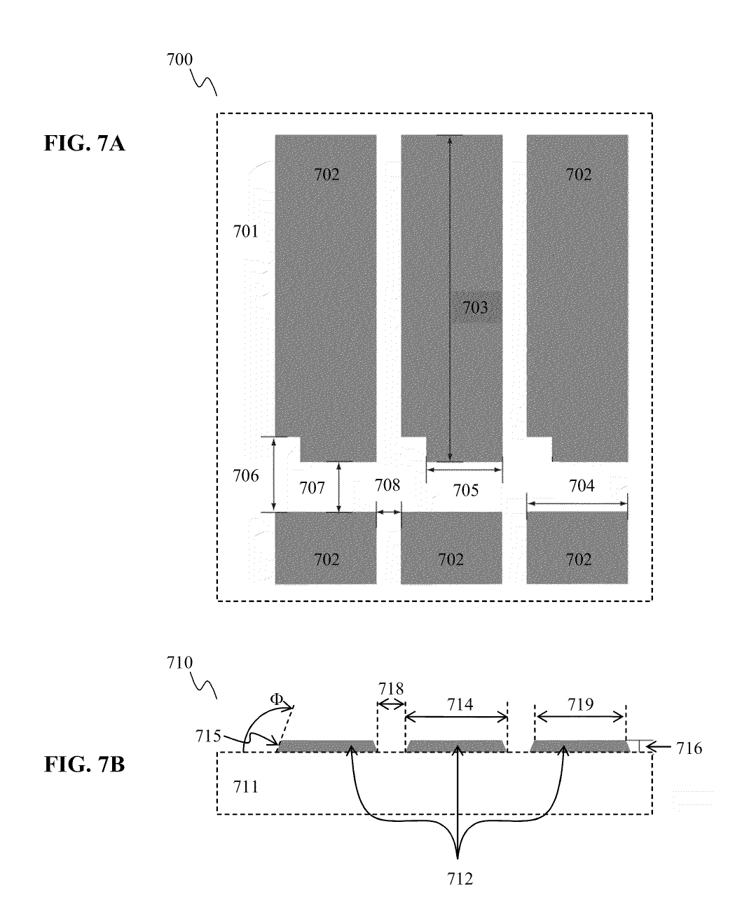

FIGS. 7A and 7B provide schematic top-view and cross sectional schematic representations, respectively, of a composition of the present invention. Referring to FIG. 7A, a schematic top-view representation of a composition is provided, 700, the composition comprising a substrate, 701, having a resist composition, 702, forming a pattern thereon. The resist composition includes lateral dimensions 703, 704 and 705. In some embodiments, at least one of the lateral dimensions, 703, 704 or 705, is 50 μm or less. The pattern also includes spacings 706, 707 and 708. At least one of the spacings, 706, 707 and 708, has a dimension of 50 μm or less.

Referring to FIG. 7B, a schematic cross-sectional representation of a composition is provided, 710, the composition comprising a substrate, 711, having a resist composition, 712, forming a pattern thereon. The resist composition has a lateral dimension, 714, and a spacing, 718. In some embodiments, the pattern has an angled sidewall, 715, that can vary to provide pattern having a tapered, blocked, or protruding profile. For example, a sidewall of a pattern can form an angle, Φ, with the surface of the substrate of 40° to 140°. In some embodiments, a sidewall of a pattern is protruding and forms an angle, Φ, with the substrate of about 50°, about 60°, about 70°, about 75°, about 80°, or about 85°. In some embodiments, the sidewall of a pattern is tapered and forms an angle, Φ, with the substrate of about 140°, about 130°, about 120°, about 110°, about 105°, about 100°, or about 95°. In some embodiments, the sidewall of a pattern is blocked and forms an angle, Φ, with the substrate of about 90°. For a pattern having protruding and/or tapered sidewalls, the pattern has a second lateral dimension, 319, that corresponds to the lateral dimension of the top portion of the resist pattern.

In some embodiments, a composition comprising a substrate having a resist composition forming a pattern thereon includes a thermoelastic polymer pattern having pores of 5 μm or less, 3 μm or less, 2 μm or less, 1 μm or less, 700 nm or less, 500 nm or less, 400 nm or less, 300 nm or less, 200 nm or less, 150 nm or less, 100 nm or less, 50 nm or less, 20 nm or less, or 10 nm or less.

In some embodiments, the present invention is directed to a substrate having a thermoelatic polymer pattern thereon, the thermoelastic polymer pattern comprising polystyrene-poly(ethylene/butylenes)-polystyrene triblock copolymer, grafted with maleic anhydride (“SEBMA”) having pores of about 200 nm to about 300 nm in diameter.

In some embodiments, the patterned compositions of the present invention have an average of 2 defects or less per 100 features. In some embodiments, the patterned compositions of the present invention have an average of 1 defect or less per 10,000 mm². As used herein, a “defect” is an error in the resist pattern. Defects can include but are not limited to: bridging and/or pairing between adjacent features of a pattern, missing pixels from a pattern, and distortion of a pattern as a result of tearing, bending, and the like.

In some embodiments, a “defect rate” or “percentage of defects” present in a composition can be determined by counting the number of defects per 100 features, or alternatively dividing the total number of defects by total the number of features and multiplying by 100%. In some embodiments, the patterned compositions of the present invention have an average of 2 or less, 1.5 or less, 1 or less, 0.5 or less, 0.2 or less, 0.1 or less, 0.05 or less, 0.01 or less, 0.005 or less, 0.001 or less, or 0.0005 or less defects per 100 features.

In some embodiments, a “defect rate” or “percentage of defects” present in a composition can be determined by dividing the number of defects by a surface area of the pattern. The surface area of a pattern can be determined by the accounting for only the surface area covered by the pattern, or by accounting for the surface area covered by the pattern and the surface area comprising spacing between features of the pattern. In some embodiments, the patterned compositions of the present invention have an average of 1 defect or less per 5,000 mm², 10,000 mm², 15,000 mm², 20,000 mm², 25,000 mm², or 30,000 mm².

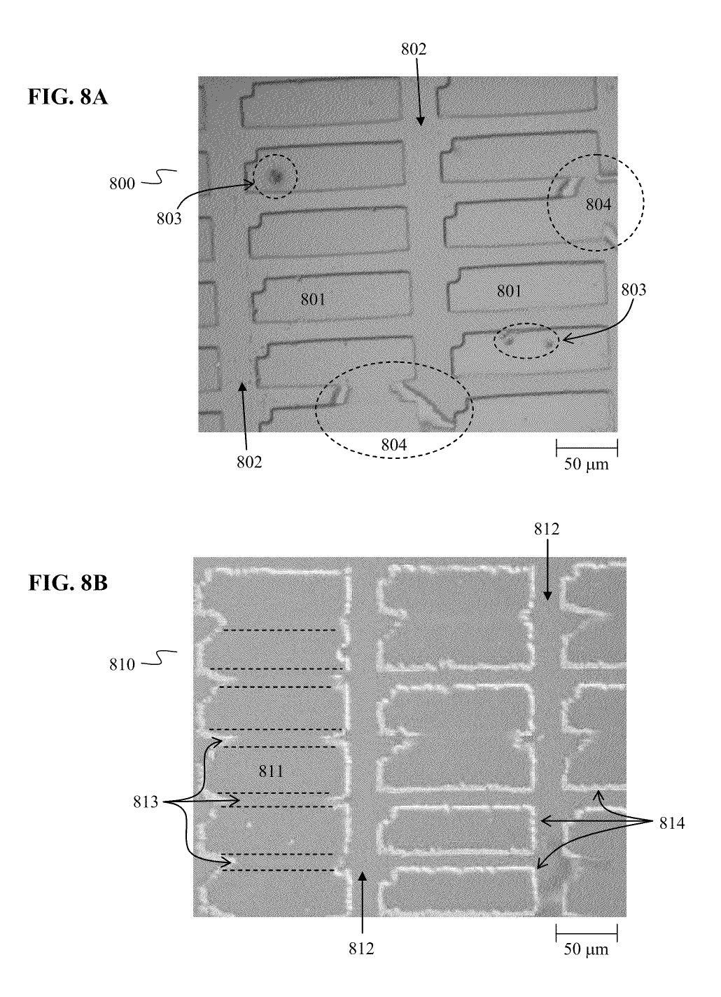

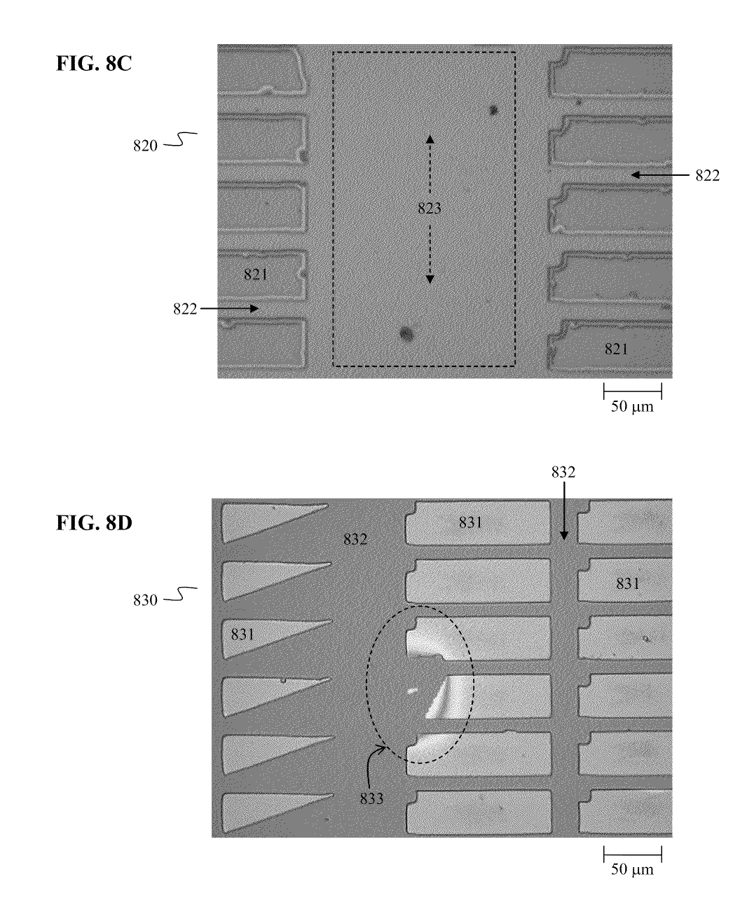

FIGS. 8A-8D provide optical microscope images of compositions having representative defects. Referring to FIG. 8A, an optical image, 800, is provided showing a substrate (270 nm thick indium tin oxide over glass), 801, having a feature, 802, etched therein. The feature includes several defects such as a pinhole, 803, and bridging, 804.

Referring to FIG. 8B, an optical image, 810, is provided showing a substrate (270 nm thick indium tin oxide over glass), 811, having a feature, 812, etched therein. The pattern includes multiple defects (indicated by dashed lines, ------), 813. The defects, 813, were induced by bridging on a resist pattern. The edges of the pattern, 814, also show perforations or uneveness that can lead to non-uniform features.

Referring to FIG. 8C, an optical image, 820, is provided showing a substrate (270 nm thick indium tin oxide over glass), 821, having a feature, 822, etched therein. The pattern includes multiple missing pixel defects, 823, in the area of the substrate delineated by a dashed line box (------).

Referring to FIG. 8D, an optical image, 830, is provided showing a substrate (270 nm thick indium tin oxide over glass), 831, having a feature, 823, etched therein. The feature includes a distortion defect, 833. Not being bound by any particular theory, the distortion defect, 833, can result from tearing or peeling of thermoelastic polymer pattern away from an area of the substrate during the application of a resist composition.

### EXAMPLES

### Example 1

A 200 mm by 200 mm square-shaped stamp comprising a flexible material (polydimethylsiloxane, “PDMS”) having a desired topography was prepared from a master using methods previously described elsewhere. See, e.g., U.S. Pat. Nos. 5,512,131 and 5,900,160, which are incorporated herein by reference in their entirety. The stamp was spin-coated with a thin layer of a resist composition comprising a thermoelastic polymer (styrene-(ethylene-butylene) triblock copolymer grafted with maleic anhydride, “SEBMA”) in a solvent (toluene), 1.5% SEBMA, by weight. The thermoelastic polymer-coated stamp was then contacted for 60 seconds with a composite substrate of a 270 nm thick indium-tin-oxide (“ITO”) layer coated on a glass support. The temperature of the substrate was maintained at 130° C. during the contacting. The stamp was then removed from the substrate, and the substrate was annealed approximately 60 s at 130° C. The resulting thermoelastic polymer pattern on the substrate had a thickness of about 300 nm, as determined by scanning profilometry.

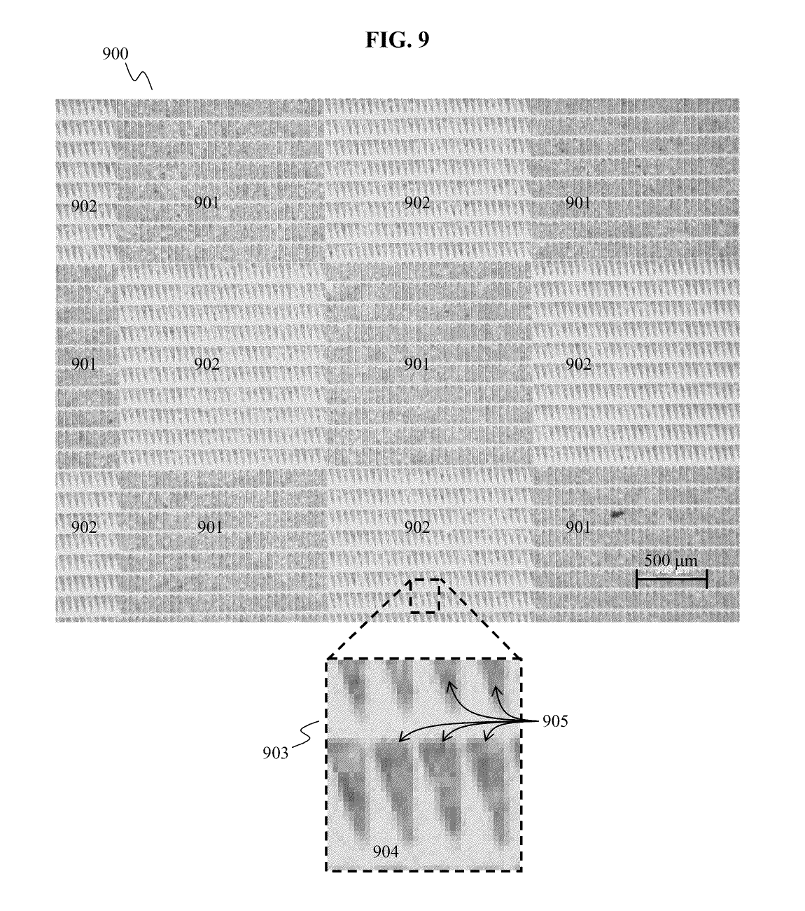

FIG. 9 provides a top-view microscope image, 900, of the patterned substrate having a thermoelastic polymer pattern thereon. The patterned substrate includes areas having a repeated rectilinear shape thereon, 901, as well as areas of the substrate having a repeating triangular shaped pattern thereon, 902. Also provided is an inset, 903, which shows that the substrate, 904, is the lighter-regions of the image, 900, while the darker areas of the image, 905, are the thermoelastic polymer pattern.

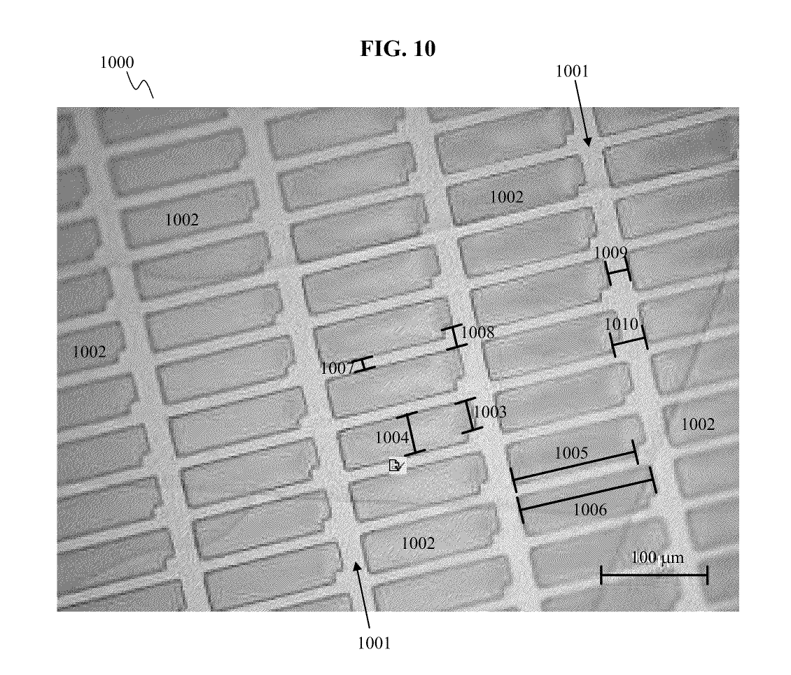

FIG. 10 provides a top-view high-resolution top-view microscope image, 1000, of the patterned substrate, 1001, having a thermoelastic polymer pattern, 1002, thereon. The thermoelastic polymer pattern has a lateral dimension, 1003, 1004, 1005 and 1006. A minimum lateral dimension of the thermoelastic polymer pattern, 1003, is about 30 μm. The thermoelastic polymer pattern of FIG. 10 can also be characterized in terms of the spacing between areas of the thermoelastic polymer pattern, having lateral dimensions, 1007, 1008, 1009 and 1010. A minimum spacing of the thermoelastic polymer pattern, 1007, is about 10 μm.

The thermoelastic polymer-patterned substrate was then reacted with an etchant (85% phosphoric acid) at 80° C. for a period of 70 seconds. The etchant was applied uniformly to the substrate by immersing the patterned substrate in the reactive composition. The etchant reacted with and removed the 270 nm-thick ITO coating from the substrate in areas that were not covered by the thermoelastic polymer pattern. After the reacting was complete, the thermoelastic polymer pattern was removed from the substrate using a solvent (toluene). The resulting subtractive non-penetrating features were similar to the features described in FIG. 1G. The features had angled sidewalls and provided isolated regions of ITO on the underlying glass substrate.

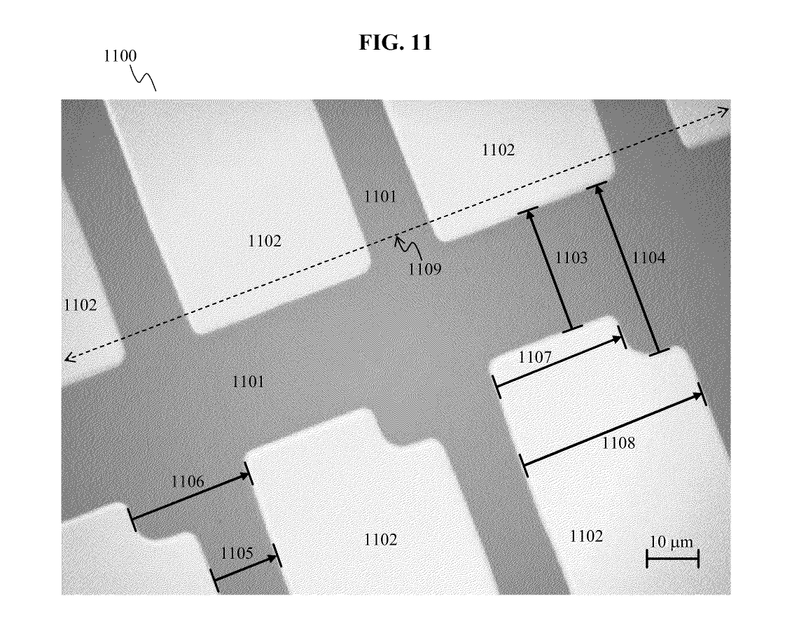

FIG. 11 provides a high-resolution top-view microscope image, 1100, of the glass substrate prepared by Example 1, from which a portion of an ITO coating has been removed. The areas of the glass substrate from which the ITO coating has been removed, 1101, have a lateral dimension, 1103, 1104, 1105 and 1106. A minimum lateral dimension of the area of the substrate from which the ITO has been removed, 1105, is about 10 μm. The areas of the substrate from which the ITO coating has been preserved, 1102, can be characterized by the lateral dimensions of the “ITO islands” which have lateral dimensions, 1107 and 1108.

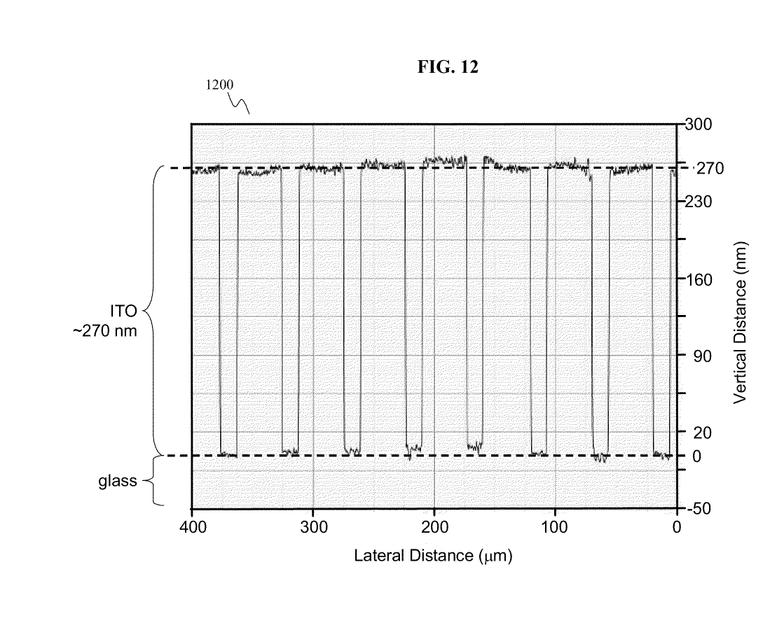

The vertical dimensions of the subtractive non-penetrating features prepared in Example 1 were characterized by scanning profilometry. Referring to FIG. 11, the patterned substrate was scanned using a surface profilometer along a path indicated by the dashed double arrow, 1109 (<----->). FIG. 12 provides a graphical representation of scanning profilometry data obtained from the substrate prepared in Example 1. Referring to FIG. 12, the graph, 1200, provides a plot of vertical distance (nm) versus lateral distance (μm). The surface of the glass substrate is zero on the vertical distance scale, and the highest vertical displacement on the graph is approximately 270 nm, corresponding to the surface of the ITO.

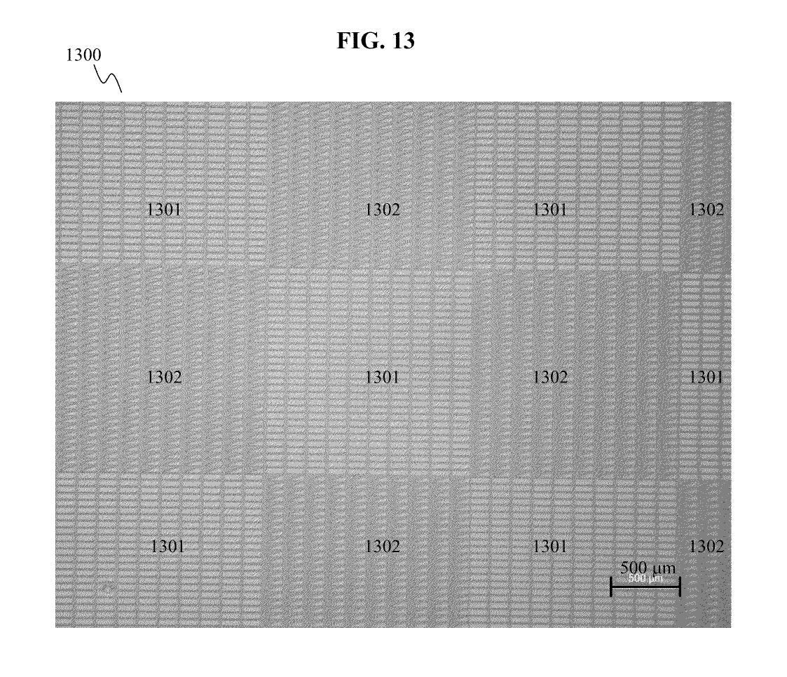

The patterning process was repeated for two additional samples of ITO-coated glass substrate. FIG. 13 provides a top-view microscope image, 1300, of a patterned substrate from which a portion of an ITO coating has been removed by the method of Example 1. Referring to FIG. 13, the patterned substrate includes areas comprising rectilinear-shaped ITO islands, 1301, as well as triangular shaped ITO-islands, 1302, on a glass substrate.

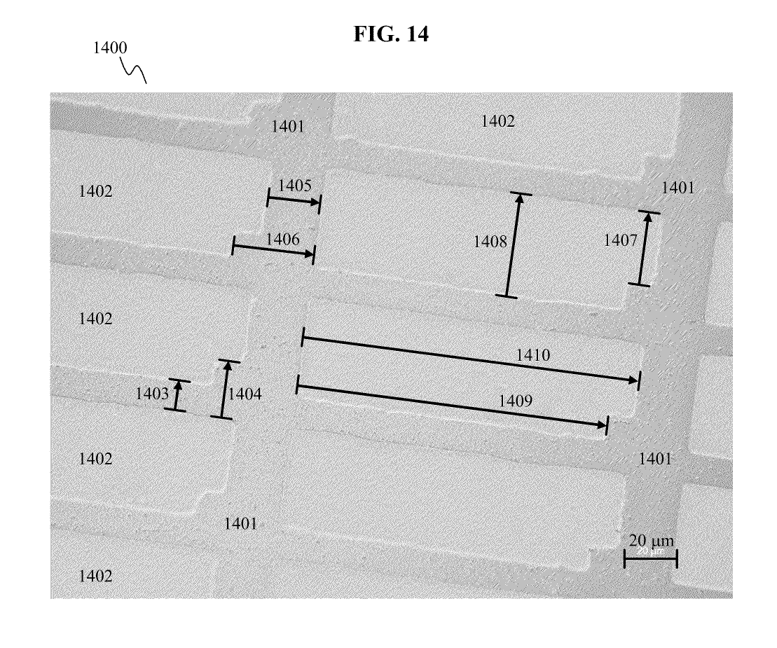

FIG. 14 provides a high resolution top-view microscope image, 1400, of a patterned substrate, 1401, from which a portion of an ITO coating has been removed by the method of Example 1. Referring to FIG. 14, the areas of the glass substrate from which the ITO coating has been removed, 1401, have a lateral dimension, 1403, 1404, 1405 and 1406. A minimum lateral dimension of the area of the substrate from which the ITO has been removed, 1403, is about 10 μm. The rectilinear areas of the substrate from which the ITO coating has been preserved, 1402, can be characterized by the lateral dimensions of the “ITO islands” which have lateral dimensions, 1407, 1408, 1409 and 1410. A minimum lateral dimension of the rectilinear ITO island, 1403, is about 30 μm.

### Example 2

The patterned substrates prepared in Example 1 were quantitatively analyzed to determine the type and number of defects as well as the average feature size of the patterns formed. The results are summarized in Table 1. The top-lateral dimension (“TLD”) refers to the lateral dimension of the subtractive non-penetrating features as measured on the surface of the substrate (i.e., lateral dimension 165 in FIG. 1G). The first lateral dimension measured at the base of the feature (“BLD1”) refers to the lateral dimension of the subtractive non-penetrating feature at the base of the feature (i.e., lateral dimension 169 in FIG. 1G). The difference between these lateral dimension, Δ, is related to the sidewall angle. The features had a height of 270 nm.

TABLE 1
Defect rate and lateral dimensions of subtractive
non-penetrating features formed in a composite substrate
(ITO on glass), as described in Example 1.

| Avg. Per | | | | |
|---|---|---|---|---|
| 100 Features | Sample 1 | Sample 2 | Sample 3 | Average |
| Bridging | 0 | 0 | 0 | 0 |
| Defects | | | | |
| Pairing | 0 | 0 | 0 | 0 |
| Defects | | | | |
| Tearing | 1.47 | 0.73 | 0.2 | 0.8 |
| Defects | | | | |
| Missing | 0.27 | 1 | 0 | 0.42 |
| Pixel | | | | |
| Defects | | | | |
| Other | 0.07 | 0.2 | 0.33 | 0.2 |
| Defects | | | | |
| Total | 1.81 | 1.93 | 0.53 | 1.42 |
| Defects | | | | |
| (Per 100 | | | | |
| Features) | | | | |
| TLD^{a} (μm) | 13.7 ± 0.28 | 13.9 ± 0.22 | 13.9 ± 0.28 | 13.8 ± 0.28 |
| BLD1^{a} (μm) | 12.0 ± 0.19 | 12.0 ± 0.10 | 12.3 ± 0.31 | 12.1 ± 0.26 |
| Δ (TLD − | 1.7 | 1.9 | 1.6 | 1.7 |
| BLD1, μm) | | | | |

^{a}TLD and BLD1 correspond to measurement of the lateral dimensions at the surface and base of feature 1004 in FIG. 10.

As shown in Table 1, the samples prepared by the method of Example 1 had an average defect rate of 1.42 defects per 100 features, and an average deviation of about 280 nm from the targeted lateral dimension of 13 μm.

### Example 3

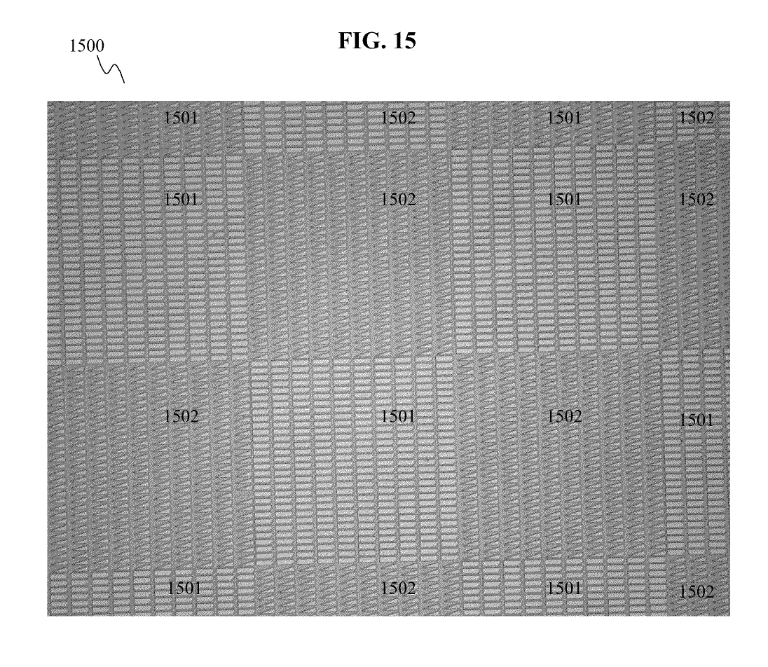

The patterning method described in Example 1 was used to pattern a 200 mm×200 mm square glass substrate having a 270 nm ITO coating thereon. The resulting pattern of ITO islands surrounded by subtractive non-penetrating features is shown in FIG. 15. Referring to FIG. 15, a top-view microscope image, 1500, of a patterned substrate from which a portion of an ITO coating has been removed is provided. The patterned substrate includes areas comprising rectilinear-shaped ITO islands, 1501, as well as triangular shaped ITO-islands, 1502, on a glass substrate.

### Example 4

The materials listed in Table 2 were dissolved in toluene (1%-2.5% w/v) or water (Examples 4-1, 4-2, 4-3, 4-14, 4-25, 4-31, 4-36, 4-38, 4-39, 4-43, 4-46, 4-49, 4-51 and 4-52; 1%-2.5% w/v) and applied to a stamp by either spin coating or spray coating. The coated stamps were then contacted with a composite substrate (surfaces included Au, Cu, SiO₂, SiN_{X}, ITO, and Al) for an amount of time sufficient to transfer the material from the coated stamps to the substrate. The resist compositions and substrates that were tested are listed in Table 2. In some embodiments, the resist composition on the substrate surface was further annealed prior to reacting with a reactive composition. The patterned substrates were then reacted with a reactive composition (e.g., an etchant). The composition of the reactive compositions and the reaction time and temperature were as follows:
A. Patterned substrates having a gold surface were reacted with TRANSENE®TFA Gold Etchant (TRANSENE CO., INC., Danvers, Mass.) for 10-30 seconds at room temperature (approximately 22° C.).
B. Patterned substrates having an aluminum surface were reacted with MERCK® paste (MERCK KGAA, Darmstadt, Germany) for 10-30 seconds at a temperature of 100° C.
C. Patterned substrates having a copper surface were reacted with TRANSENE®Copper Etch APS-100 ammonium perchlorate etchant (TRANSENE CO., INC.) for 10-30 seconds at room temperature (approximately 22° C.).
D. Patterned substrates having an indium tin oxide (ITO) surface were reacted with 85% aqueous phosphoric acid for 70 seconds at 80° C.
E. Patterned substrates having a silicon (Si) surface were reacted with TRANSENE® RSE-100 etchant (TRANSENE CO., INC.) for 10-30 seconds at room temperature (approximately 22° C.).
F. Patterned substrates having a silicon dioxide (SiO₂) surface were reacted with MERCK® paste (MERCK KGAA, Darmstadt, Germany) for 10-30 seconds at room temperature (approximately 22° C.).
G. Patterned substrates having a silicon nitride (SiNₓ) surface were reacted with either 85% aqueous phosphoric acid for 10-30 seconds at 120° C.; or TRANSETCH®-N (TRANSENE CO., INC.) for 10-30 seconds at 120° C.
H. Patterned substrates having a titanium (Ti) surface (30 nm-thick Ti film on Si wafers) were reacted with any one of: concentrated sulfuric acid and TRANSENE® TFTN Titanium Etch (TRANSENE CO., INC.) for 10-30 seconds at 70° C.

TABLE 2
Materials used as resists with various substrates in which patterning of the
resist composition on a substrate was performed by a method of the present
invention according to Example 4.

| Ex. | Material | MW | T_{g} (° C.) | MP (° C.) | YM (GPa) | Substrate |
|---|---|---|---|---|---|---|
| 4-1 | Polyvinylpyrollidone^{1,}* | 8k | 110 | 130 | — | ITO/glass |
| 4-2 | Polyvinylpyrollidone¹ | 40-80k | 175 | — | ≧130 | ″ |
| 4-3 | Polyvinylpyrollidone¹ | 630k | 175 | — | ≧130 | ″ |
| 4-4 | Poly(epichlorohydrin-co-ethylene oxide)² | — | −30 | — | — | ″ |
| 4-5 | Poly(methylmethacrylate)² | ~120k | 99 | — | 3-3.4 | SiNₓ |
| 4-6 | Polystyrene-block-polybutadiene-block-polystyrene (branched, 21 wt-% | — | — | — | <0.02 | ITO/glass |
| | polystyrene)² | | | | | |
| 4-7 | Poly(styrene-co-butadiene)² | — | −52 | 93 | 1.4 | ″ |
| 4-8 | Polystyrene² | 230k | 94 | 100 | 0.035 | ″ |
| 4-9 | Poly(vinyl chloride)² | 233k | — | 130-180 | 2.964 | ″ |
| 4-10 | Poly(acrylic acid)² | 450k | 106 | — | — | ″ |
| 4-11 | Polystyrene-block-polyisoprene-block-polystyrene | — | — | — | <0.02 | SiNₓ |
| | (28 wt-% styrene)² | | | | | ITO/glass |
| | | | | | | Al |
| 4-12 | Polystyrene-block-poly(ethylene-ran-butylene)-block-polystyrene² | 118k | — | — | <0.02 | ITO/glass |
| 4-13 | Poly(acrylonitrile-co-butadiene-co-acrylic acid), dicarboxy terminated² | 3.6k | −52 | — | — | ″ |
| 4-14 | Polyethyleneimine² | — | — | — | — | ″ |
| 4-15 | Poly(acrylonitrile-co-butadiene-co-styrene)² | — | | ~95 | 3.3-3.9 | ″ |
| 4-16 | Polystyrene-block-poly(ethylene-ran-butylene)-block-polystyrene (29 wt- | 89k | −40 | — | <0.02 | ″ |
| | % styrene)² | | | | | |
| 4-17 | Poly(styrene-co-butadiene) (10 wt-% styrene)² | — | −52 | ~95 | <0.02 | ″ |
| 4-18 | Poly(acrylonitrile-co-butadiene), amine terminated | 1.2k | −65 | — | 3.3-3.9 | ″ |
| | (10 wt-% acrylonitrile)² | | | | | |
| 4-19 | Poly(4-vinylpyridine-co-styrene) | — | | — | | ″ |
| 4-20 | Polystyrene-block-poly(ethylene-ran-butylene)-block-polystyrene, | — | | — | <0.02 | ″ |
| | sulfonated, cross-linkable 5solution² | | | | | |
| 4-21 | Polystyrene-block-poly(ethylene-ran-butylene)-block-polystyrene-graft- | — | | — | <0.02 | ITO/glass |
| | maleic anhydride² | | | | | SiO₂ |
| | | | | | | Al |
| | | | | | | Cu |
| | | | | | | Si |
| | | | | | | Ti/Si |
| | | | | | | SiNₓ |
| 4-22 | Poly(styrene-co-maleic anhydride)² | ~224k | 120 | — | — | ITO/glass |
| 4-23 | Poly(vinyl chloride)² | 43k | — | — | 2.96 | ″ |
| 4-24 | Poly(1,4-butylene terephthalate)² | — | 46 | 228 | 2 | ″ |
| 4-25 | Polypropylene² | 190k | — | 160-165 | 1.03-1.72 | ″ |
| 4-26 | Poly(vinyl alcohol)² | 30-70k | — | — | 30 | ″ |
| 4-37 | Polylimonene² | — | 63 | 115 | — | ″ |
| 4-28 | Poly(vinyl alcohol-co-ethylene) | — | 55 | 165 | 2.7 | ″ |
| | (44 mol-% ethylene)² | | | | | |
| 4-29 | Poly(methyl methacrylate)² | 15k | 82 | — | 2.4-3 | SiNₓ |
| 4-30 | Poly[N,N′-(1,3-phenylene)isophthalamide]² | — | — | 371 | | ITO/glass |
| 4-31 | Polyethylenimine solution, 30 wt-% in H₂O | — | — | — | ?? | ″ |
| | (80% ethoxylated)² | | | | | |
| 4-32 | Polynorbornene² | 2,000k | — | — | — | ″ |
| 4-33 | Poly(methyl methacrylate-co-methacrylic acid)² | 34k | 105 | — | — | ″ |
| 4-34 | Poly(carbonate urethane)² | 237k | — | — | — | ″ |
| 4-45 | Poly(1,4-phenylene ether-ether-sulfone)² | — | 192 | — | — | ″ |
| 4-36 | Poly(ethylene oxide)² | 100k | −67 | 65 | — | ″ |
| 4-37 | Poly[butylene terephthalate-co-poly(alkylene glycol) terephthalate]² | — | — | 203 | — | ″ |
| 4-38 | Poly(ethylene glycol) diacrylate² | 575 | −30 | — | 0.12 | ″ |
| 4-39 | Polyethylenimine solution, 35-40 wt-% in H₂O | 70k | — | — | — | ″ |
| | (80% ethoxylated)² | | | | | |
| 4-40 | Poly(acrylonitrile-co-butadiene), dicarboxy terminated | 3.8k | −66 | — | 3.3-3.9 | ″ |
| | (8-12 wt-% acrylonitriile)² | | | | | |
| 4-41 | Polyisoprene, cis (natural)² | 38k | −72 | — | 0.0013 | ″ |
| 4-42 | Poly(methylmethacrylate-co-methacrylic acid)² | 34k | 105 | — | — | ″ |
| 4-43 | Poly(4-vinylpyridine)² | 60k | 137 | — | — | ″ |
| 4-44 | Poly(DL-lactide)² | 75-120k | 32.9 | 262 | — | ″ |
| 4-45 | Poly(3,3′,4,4′-benzophenonetetracarboxylic dianhydride-co-4,4′- | — | — | — | — | ″ |
| | oxydianiline/1,3-phenylenediamine), amic acid solution² | | | | | |
| 4-46 | Poly(1,4-phenylene sulfide)² | 10k | 150 | — | 3.4-3.4 | ″ |
| 4-47 | Polystyrene-block-poly(ethylene-ran-butylene)-block-polystyrene (31 wt- | — | — | — | <0.02 | ″ |
| | % styrene)² | | | | | |
| 4-48 | Eicosane² | 282.55 | — | 35-37 | — | ″ |
| 4-49 | Agarose, PFGE GPG³ | | — | 86-89 | — | ″ |
| 4-50 | Poly(methacrylic acid sodium salt)⁴ | 75k | — | — | — | ″ |
| 4-51 | Agarose⁵ | | — | — | — | ″ |
| 4-52 | DisperseEZ-200W1 polytetrafluoroethylene particles⁶ | 1 × 10⁶ | — | — | — | ″ |
| 4-53 | Polyvinylidene fluoride homopolymer (KYNAR ®)⁷ | — | −30 | 155-165 | 1-1.4 | ″ |
| 4-54 | Polyvinylidene fluoride homopolymer (KYNAR ®)⁷ | — | −40 | 158-172 | 1.3-2.3 | SiNₓ |
| 4-55 | Polyvinylidene fluoride copolymer HFP (KYNAR ®)⁷ | — | −30 | 148-152 | 1.1 | SiNₓ |
| 4-56 | Polyvinylidene fluoride copolymer HFP (KYNAR ®)⁷ | — | −30 | 151-155 | 1.1 | SiNₓ |
| 4-57 | Polyvinylidene fluoride copolymer HFP (KYNAR ®)⁷ | — | −40 | 155-160 | 1.0-1.5 | SiNₓ |
| 4-58 | Polyvinylidene fluoride copolymer HFP (KYNAR ®)⁷ | — | −30 | 140-145 | 1.1 | SiNₓ |
| 4-59 | Polyvinylidene fluoride homopolymer (KYNAR ®)⁷ | — | −40 | 165-172 | 1.3-2 | SiNₓ |
| 4-60 | Styrene-butadiene-styrene block copolymer | — | — | — | 0.0024 | ITO/glass |
| | (21-25 wt-% styrene)⁸ | | | | | SiNx |
| 4-61 | Styrene-ethylene-butylene block linear copolymer | — | — | — | <0.02 | ″ |
| | (13 wt-% styrene)⁸ | | | | | ″ |
| 4-62 | Styrene-ethylene-butylene block linear copolymer | — | — | — | 0.0024 | ″ |
| | (13 wt-% styrene)⁸ | | | | | ″ |
| 4-63 | Multi-arm block copolymer based on ethylene/propylene⁸ | — | — | — | <0.02 | ″ |
| | | | | | | ″ |
| 4-64 | Styrene-butadiene-styrene block copolymer | — | — | — | 0.0034 | ″ |
| | (36 wt-% styrene)⁸ | | | | | ″ |
| 4-65 | Styrene-butadiene-styrene block copolymer | — | — | — | 0.0027 | ″ |
| | (31 wt-% styrene)⁸ | | | | | ″ |
| 4-66 | P(EA/MMA) copolymers resins, (PLEXIGLAS ®)⁷ | — | — | 187-208sp | 1.862 | ITO/glass |
| 4-67 | Styrene butadiene copolymer (STYROFLEX)⁹ | n/a | −40 | 48 | 0.128 | SiO₂ |
| | | | | | | Al |
| | | | | | | Au |
| | | | | | | Si |
| | | | | | | ITO/glass |
| 4-68 | Acrylite Plus acrylic, polymethyl methacrylate¹⁰ | n/a | — | 94 sp | 1.5 | ITO/glass |
| 4-69 | Phenolic resin (TAMANOL PA)¹¹ | n/a | — | 90-100sp | — | ″ |
| 4-70 | Ketone Resin K-90¹¹ | n/a | — | — | — | ″ |
| 4-71 | Teflon AF 4,5-Difluoro-2,2-bis(trifluoromethyl)-1,3-dioxale w/ PTFE¹² | — | −77 | 335-345 | 1.54-1.55 | ″ |
| 4-72 | Teflon AF 4,5-Difluoro-2,2-bis(trifluoromethyl)-1,3-dioxane w/ PTFE¹² | — | −77 | 335-345 | 1.54-1.55 | ″ |
| 4-73 | ETCHALL ®^{,13} | — | — | — | — | Au |
| | | | | | | Cu |
| | | | | | | SiO₂ |
| 4-74 | SU-8 photoresist¹⁴ | — | — | 210 sp | 2 | ITO/glass |
| 4-75 | LOR 3A photoresist¹⁵ | — | — | — | — | ″ |
| 4-76 | SHIPLEY ® 1813 Photoresist¹⁵ | — | — | — | — | ″ |
| 4-77 | STR 1045 photoresist | — | — | — | — | ″ |
| 4-78 | AZ 5214 photoresist¹⁶ | — | — | — | — | Au |
| | | | | | | Al |
| 4-79 | LOR 3A photoresist¹⁵ | — | — | — | — | ITO/glass |
| 4-80 | SHIPLEY ® S1805 photoresist¹⁵ | — | — | — | — | ″ |
| 4-81 | OMNICOAT ®^{,14} | — | — | — | — | ″ |
| 4-82 | SHIPLEY ® SPR-220 positive photoresist¹⁵ | — | — | — | — | ″ |
| 4-83 | AZ P4330-RS positive photoresist¹⁶ | — | — | — | — | ″ |
| 4-84 | KMPR 1005 negative photoresist¹⁴ | — | — | — | — | ″ |
| 4-85 | ETA24/3257 B thermal resist | — | — | — | — | ″ |
| 4-86 | APIEZON ® black wax back-side resist¹⁷ | — | — | — | — | ″ |
| 4-87 | PROTEK ® B3-25 back-side resist¹⁸ | — | — | — | — | ″ |
| 4-88 | Sylvarez TP 2040¹⁹ | — | — | — | — | ″ |
| 4-89 | SYLVAGUM ® TR 105¹⁹ | — | — | — | — | ″ |
| 4-90 | Xantham Gum⁴ | — | — | — | — | ″ |
| 4-91 | Primal AC-261 Emulsion¹⁵ | — | — | — | — | ″ |
| 4-92 | TACOLYN ® 3509²⁰ | — | — | — | — | ″ |
| 4-93 | Flexwax²¹ | — | — | — | — | ″ |

¹ALFA AESAR (Ward Hill, MA)
*Polyvinylpyrrolidone was deposited onto a stamp comprising a flexible material from an aqueous solution.
²SIGMA-ALDRICH CO. (Saint Louis, MO)
³AMERICAN BIOANALYTICAL, INC. (Natick, MA)
⁴FLUKA (SIGMA-ALDRICH CO., Saint Louis, MO)
⁵EMD CHEMICALS, INC. (Merck KGaA, Darmstadt, DE)
⁶POLYSCIENCES, INC. (Warrington, PA)
⁷ARKEMA INC. (Philadelphia, PA)
⁸KRATON POLYMERS LLC (Houston, TX)
⁹BASF CORP. (Florham Park, NJ)
¹⁰EVONIK INDUSTRIES (Darmstadt, DE)
¹¹ARAKAWA CHEMICAL INC. (Chicago, IL)
¹²E.I DU PONT DE NEMOURS AND CO. (Wilmington, DE).
¹³B&B PRODUCTS, INC. (Peoria, AZ)
¹⁴MICROCHEM CORP. (Newton, MA)
¹⁵ROHM AND HAAS Co. (Philadelphia, PA)
¹⁶CLARIANT CORP (Charlotte, NC)
¹⁷M&I MATERIALS LTD. (Manchester, UK)
¹⁸BREWER SCIENCE INC. (Rolla, MO)
¹⁹ARIZONA CHEMICAL CO. (Jacksonville, FL)
²⁰EASTMAN CHEMICAL CO. (Kingsport, TN)
²¹AMOCO CHEMICAL CO. (Chicago, IL)

Referring to Table 2, under the conditions tested, resist compositions comprising a thermoelastic polymer exhibited superior performance in terms of both print quality and etch resistance.

In some embodiments, under the conditions tested the commercially available photoresists (e.g., Examples 4-75, 4-76, 4-77, 4-79, 4-80, 4-81, 4-88 and 4-89) formed bridges on the stamp prior to pattern transfer. However, bridging can be avoided by dilution of the photoresist with an appropriate solvent.

In some embodiments, under the conditions tested waxes and low molecular weight polymers (e.g., PMMA and PVC) yielded coated stamps that were susceptible to cracking. However, cracking can be avoided via addition of an appropriate surface active agent or emulsifier to the etch resist formulation.

Generally, stamps were readily coated in a uniform manner by resist composition comprising high-molecular weight polymeric materials (e.g., PMMA and PVC). In some embodiments, high-molecular weight polymeric materials provided bridging on a coated stamp. However, bridging can be avoided by dilution of the high-molecular weight polymer(s) with an appropriate solvent.

In some embodiments, resins (e.g., polylimonene, sylvagum, and xantham gum) could be readily coated onto stamps by either of spin coating or spray coating.

### Example 5

Features were formed on composite substrates (ITO on glass or Al on Si) and monolithic substrates (SiO₂, Al and Cu) using SEBMA patterns. For each of the substrates a series of features were formed in which the reacting time was varied, and the effect of reacting time on the elevation and lateral dimensions of the features was examined. The vertical dimensions of the features was determined by linear profilometry. The results are compiled in Table 3.

TABLE 3
The effect on reacting time on vertical
feature dimensions was examined.

| | | Reacting | | Feature Depth |
|---|---|---|---|---|
| Ex. | Substrate | Conditions (° C.) | Time (s) | (nm) |
| 5-1 | Bulk Al | 40^{a} | 30 | 167 |
| | | | 60 | 417 |
| | | | 120 | 673 |
| | | | 240 | 1,643 |
| 5-2 | Al/Si | 40^{a} | 15 | 37 |
| | | | 30 | 107 |
| | | | 60 | 235 |
| | | | 90 | 246 |
| 5-3 | ITO/glass | 80^{a} | 10 | 55 |
| | | | 20 | 88 |
| | | | 40 | 191 |
| | | | 80 | 445 |
| 5-4 | SiO₂ | RT^{b} | 10 | 186 |
| | | | 30 | 395 |
| | | | 90 | 1,050 |
| 5-5 | Bulk Cu | RT^{c} | 40 | — |
| | | | 80 | 615 |
| | | | 160 | 1,152 |
| 5-6 | Cu/Si | RT^{c} | 35 | — |

^{a}The reactive composition was 85% phosphoric acid.
^{b}The reactive composition was Merck KGaA solar paste.
^{c}The reactive composition was 20% ammonium persulfate.

Referring to Table 3, the feature depth for all the bulk substrates increased with time. However, for composite substrates, after the surface layer of the substrate was removed by the reactive composition, the reacting was largely complete. In some embodiments, broadening of the lateral dimensions of the features was observed (e.g., for glass). Broadening of the lateral dimensions of features was also observed for composite substrates (e.g., ITO/glass) for longer reacting times.

### Example 6

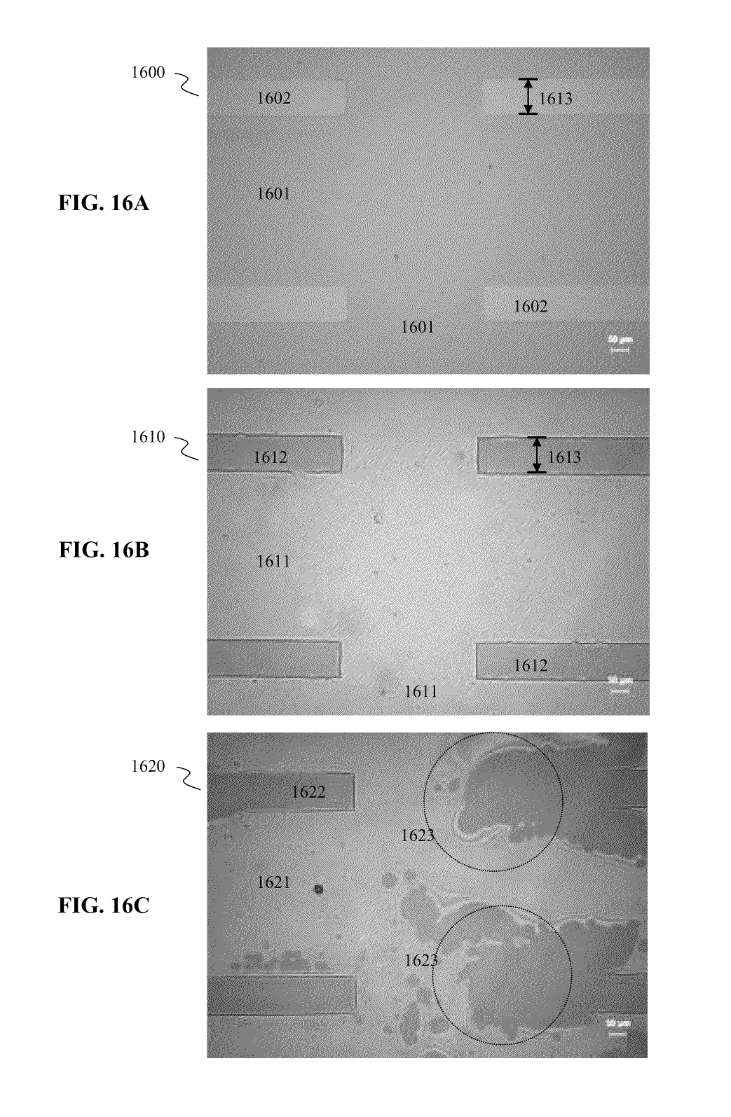

The effect of reacting temperature was examined for various substrates patterned with resist compositions comprising SEBMA. Substrates (ITO on glass) were patterned with SEBMA by the method of Example 1, and immersed in a bath comprising a reactive composition (85% aqueous phosphoric acid) for 20 s. The reactive composition was heated during the reacting to a temperature of about 80° C., about 95° C., or about 110° C. FIGS. 16A-16C provide images of the resulting features formed at these temperatures, respectively. Referring to FIGS. 16A and 16B, an image, 1600 and 1610, respectively, display a substrate, 1601 and 1611, respectively, having features, 1602 and 1612, respectively, thereon. The features in FIG. 16A have a lateral dimension, 1603, of 107 μm and a depth of 88 nm. The features in FIG. 16B have a lateral dimension, 1613, of 111 μm and a depth of 520 nm. Thus, an increase in temperature from 80° C. to 95° C. had a significant effect on the reaction rate and little effect on the lateral dimensions of the feature. Upon increasing the temperature to 110° C., the resist composition became unstable during the reacting. Referring to FIG. 16C, an image, 1620, displays a substrate, 1621, having features thereon, 1622. The features have considerable defects, 1623, due to instability of the resist composition. The features produced at 110° C. had a depth of 530 nm and a variable lateral dimension depending on the stability of the resist composition. Notably, the T_{g} of styrene is about 95° C. Thus, an optimum balance between resist stability and reaction rate when the temperature during the reacting was maintained near that of the T_{g} of one of the components of the thermoelastic polymer. Performing the reacting at a lower temperature (i.e., 80° C.) resulted in a stable resist composition but a low etch rate. On the other hand, performing the reacting above the T_{g} of a component of the thermoelastic polymer (i.e., 110° C.) resulted in substantial defects in the resist pattern, without notable increase in the reaction rate.

### Example 7

A series of trench features were produced in various substrates by a method of the present invention. SEBMA (1.5 wt-% in toluene) was spin-coated onto a stamp (PDMS having a glass backing) The coated stamp was then contacted with a substrate (i.e., Cu on Si, Al on Si, and ITO on glass), and the thermoelastic polymer pattern was transferred to the substrate. The substrate was then immersed in a bath comprising a reactive composition (85% aqueous phosphoric acid) maintained at 80° C. for 70 s, at which time the substrate was removed from the reactive composition, the substrate was washed with water, and the features were characterized.

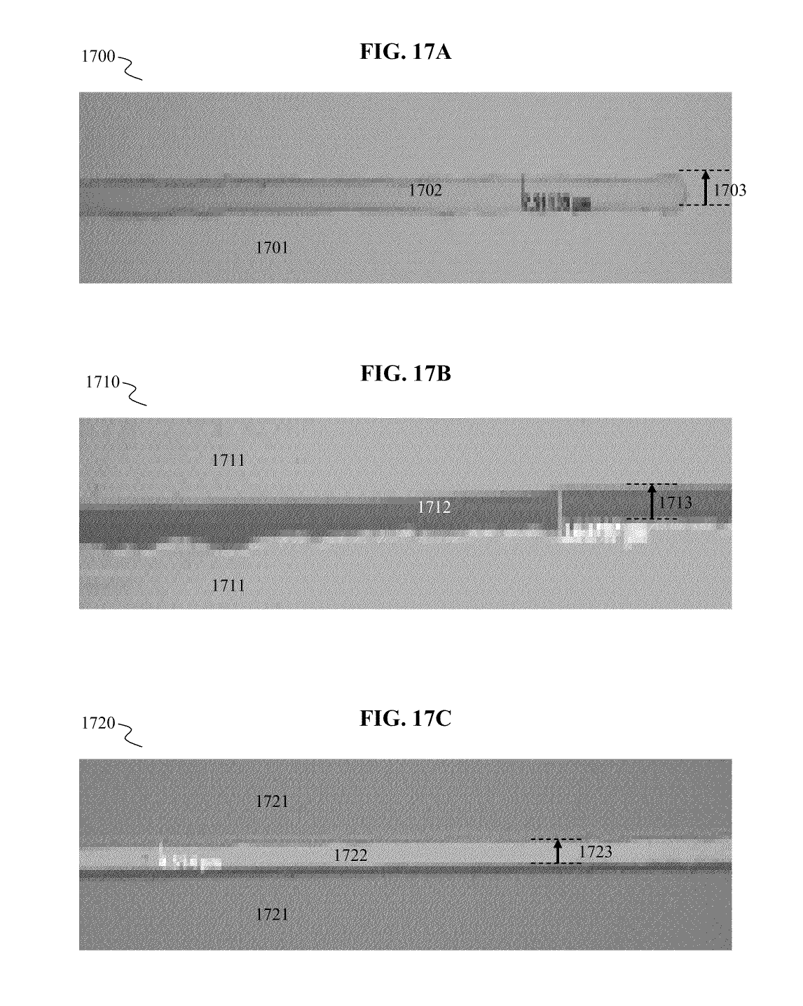

FIGS. 17A-17C provide images, 1700, 1710 and 1720, respectively, of substrates, 1701, 1711 and 1721, respectively, having features, 1702, 1712 and 1722, respectively, thereon.

Referring to FIG. 17A, the composite substrate, 1701, is a Cu film having a thickness of about 150 nm over a silicon underlayer. The feature, 1702, has a lateral dimension, 1703, of about 3 μm, and a depth of about 150 nm. The feature, 1702, thus has an aspect ratio of about 1:20.

Referring to FIG. 17B, the composite substrate, 1711, is a Cu film having a thickness of about 235 nm over a silicon underlayer. The feature, 1712, has a lateral dimension, 1713, of about 3 μm, and a depth of about 235 nm. The feature, 1712, thus has an aspect ratio of about 1:13.

Referring to FIG. 17C, the composite substrate, 1721, is an ITO film having a thickness of about 300 nm on a glass underlayer. The feature, 1722, has a lateral dimension, 1703, of about 4.5 μm, and a depth of about 300 nm. The feature, 1722, thus has an aspect ratio of about 1:15.

### CONCLUSION

These Examples illustrate possible embodiments of the present invention. While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

It is to be appreciated that the Detailed Description section, and not the Summary and Abstract sections, is intended to be used to interpret the claims. The Summary and Abstract sections can set forth one or more, but not all exemplary embodiments of the present invention as contemplated by the inventor(s), and thus, are not intended to limit the present invention and the appended claims in any way.

All documents cited herein, including journal articles or abstracts, published or corresponding U.S. or foreign patent applications, issued or foreign patents, or any other documents, are each entirely incorporated by reference herein, including all data, tables, figures, and text presented in the cited documents.

What is claimed is:

1. A resist composition consisting essentially of:
a thermoelastic polymer selected from the group consisting of: a styrene-ethylene copolymer, a styrene-ethylene block copolymer, a styrene-ethylene-butylene block copolymer, a styrene-isoprene copolymer, a styrene-butadiene copolymer, a styrene-butadiene block copolymer, a maleic anhydride-grafted styrene-ethylene block copolymer, a sulfonated styrene-alkylene block copolymer, an acrylonitrile-styrene-ethylene block copolymer, an arylene-vinylene copolymer, a polyethyleneimine polymer, methylmethacrylate-butadiene copolymer, and combinations thereof,
wherein the thermoelastic polymer has a Young's Modulus of 20 MPa or less,
wherein the thermoelastic polymer has a molecular weight of 60,000 Da to 130,000 Da,
wherein the thermoelastic polymer is present in a concentration of 0.1% to 10% by weight; and
one or more solvents in which the thermoelastic polymer has a solubility of at least 1 mg/mL, wherein the one or more solvents have a boiling point of 35° C. to 200° C.

2. The resist composition of claim 1, wherein a film or pattern prepared from the resist composition having a thickness of 100 nm absorbs 10% or less of radiation having a wavelength of about 250 nm to about 800 nm.

3. The resist composition of claim 1, wherein the resist composition has a viscosity of 0.5 cP to 10 cP.

4. The resist composition of claim 1, wherein the thermoelastic polymer has a melting point of 80° C. to 125° C.

5. The resist composition of claim 1, wherein the thermoelastic polymer has a T_{g} of −60° C. to −30° C.

6. The resist composition of claim 1, wherein the thermoelastic polymer is a styrene-ethylene-butylene block copolymer having a molecular weight of about 118,000 Da.

7. The resist composition of claim 1, wherein the thermoelastic polymer is an ethoxylated polyethyleneimine polymer having a molecular weight of about 70,000 Da.

8. The resist composition of claim 1, wherein the solvent is selected from the group consisting of: benzene, toluene, a xylene, cumene, mesitylene, propylene glycol mono-methyl ether, tetrahydrofuran, acetone, ethylacetate, methylethylketone, methylene chloride, 1,2-dichloroethane, chloroform, dimethylformamide, and combinations thereof.

9. A method for forming a feature on a substrate, the method comprising:
applying a resist composition comprising a thermoelastic polymer to a surface of a stamp to provide a coated stamp, wherein the stamp comprises a flexible material and has a surface including at least one indentation therein, the indentation being contiguous with and defining a pattern in the surface of the stamp;
contacting the coated stamp with a substrate for an amount of time and at a temperature sufficient to transfer the thermoelastic polymer from the stamp surface to the substrate, wherein the thermoelastic polymer covers the substrate in a pattern according to the pattern in the surface of the stamp;
separating the stamp from the substrate; and
reacting an area of the substrate not covered by the thermoelastic polymer pattern to a reactive composition to form a feature thereon,
wherein the pattern in the surface of the stamp defines a lateral dimension of the feature.

10. The method of claim 9, wherein the thermoelastic polymer has a Young's Modulus of 1 MPa to 20 MPa.

11. The method of claim 9, wherein the thermoelastic polymer has a T_{g} of 25° C. or less.

12. The method of claim 11, wherein the thermoelastic polymer comprises a second polymer having a T_{g} of 25° C. or greater.

13. The method of claim 9, wherein the thermoelastic polymer is selected from the group consisting of: a styrene-butadiene copolymer, a styrene-isoprene copolymer, a polystyrene-poly(ethylene/butylene)-polystyrene triblock copolymer grafted with maleic anhydride, and combinations thereof.

14. The method of claim 9, further comprising annealing the thermoelastic polymer on the surface of the stamp, the substrate, or a combination thereof.

15. The method of claim 9, wherein the temperature of at least one of the stamp, the substrate, and the thermoelastic polymer is maintained at or above a T_{g} of the thermoelastic polymer during the contacting.

16. The method of claim 9, wherein the substrate is maintained at a temperature at or below a T_{g} of the thermoelastic polymer during the reacting.

17. The method of claim 9, wherein the substrate is maintained at a temperature of 30° C. to 150° C. during the reacting.

18. The method of claim 9, wherein the reacting is performed for 0.5 seconds to 300 seconds.

19. The method of claim 9, further comprising removing the thermoelastic polymer pattern from the substrate.

20. The method of claim 9, wherein the reacting further comprises exposing the substrate to a reaction initiator selected from the group consisting of: thermal energy, radiation, acoustic waves, a plasma, an electron beam, a stoichiometric chemical reagent, a catalytic chemical reagent, a reactive gas, an increase or decrease in pH, an increase or decrease in pressure, electrical current, agitation, friction, and combinations thereof.

21. The method of claim 9, wherein the reactive composition comprises a species selected from the group consisting of: an acid, a base, a halogen-containing compound, a halide, and combinations thereof.

22. A composition comprising: a stamp comprising a flexible material, the stamp having a surface including at least one indentation therein, the indentation being contiguous with and defining a pattern in the surface of the stamp, and the surface of the stamp having a resist composition thereon, the resist composition comprising a thermoelastic polymer having a Young's Modulus of 20 MPa or less and a molecular weight of 60,000 Da to 130,000 Da.

23. The composition of claim 22, wherein the coating on the stamp surface absorbs 10% or less of radiation having a wavelength of about 250 nm to about 800 nm for 100 nm of pattern thickness.

24. The composition of claim 22, wherein the thermoelastic polymer has a melting point of 80° C. to 125° C.

25. The composition of claim 22, wherein the thermoelastic polymer has a T_{g} of −60° C. to −30° C.

26. The composition of claim 22, wherein the resist composition has a thickness of 25 nm to 10 μm and forms a discontinuous coating on the stamp.

27. A composition comprising: a substrate having a thermoelastic polymer pattern thereon, wherein the pattern has at least one spacing of 50 μm or less, the thermoelastic polymer has a Young's Modulus of 20 MPa or less and a molecular weight of 60,000 Da to 130,000 Da, and the pattern absorbs 10% or less of radiation having a wavelength of about 250 nm to about 800 nm for 100 nm of pattern thickness.

28. The composition of claim 27, wherein the thermoelastic polymer has a melting point of 80° C. to 125° C.

29. The composition of claim 27, wherein the thermoelastic polymer has a T_{g} of −60° C. to −30° C.

30. The composition of claim 27, wherein the pattern has a vertical dimension of 25 nm to 10 μm.

31. The composition of claim 27, wherein the pattern has 2 defects or less per 100 features.
